(19) United States
(12) Patent Application Publication
(10) Pub. No.: US 2007/0298259 A1
(43) Pub. Date: Dec. 27, 2007

(54) Polymer coated metal oxide fine particles and their applications

(76) Inventor: Takeshi Matsumoto, Takatsuki-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/812,163

(22) Filed: Jun. 15, 2007

(30) Foreign Application Priority Data
Jun. 16, 2006 (JP) 2006-167851
Jun. 16, 2006 (JP) 2006-167874

(51) Int. Cl. B32B 15/08; B01F 3/12; C08K 9/10

(52) U.S. Cl. 428/407; 106/287.1; 252/363.5; 523/205

(57) ABSTRACT

The present invention provides polymer-coated metal oxide fine particles, including metal oxide fine particles having a number-average particle diameter of not smaller than 1 nm and not greater than 100 nm, a surface of each of the metal oxide fine particles being coated with a polymer; and the present invention further provides, as their applications, for example, an aqueous dispersion of polymer-coated metal oxide fine particles and a process for their production, coating compositions, resin compositions, and resin formed articles.

### BACKGROUND OF THE INVENTION

The present application claims the benefit of priority from Japanese Patent Applications Nos. 2006-167851 and 2006-167874, both filed on Jun. 16, 2006, all the contents of which are incorporated herein by reference.

### FIELD OF THE INVENTION

The present invention relates to polymer-coated metal oxide fine particles and their applications, and more specifically, it relates to polymer-coated metal oxide fine particles and as their applications, for example, aqueous dispersions of polymer-coated metal oxide fine particles and processes for their production, coating compositions, resin compositions, resin formed articles, and the like.

### DESCRIPTION OF THE RELATED ART

In general, the exterior of buildings and bridges are finished, for example, by coating. The outer walls of such buildings and the surfaces of such bridges are exposed to wind and rain in the open air, and therefore, their coating films may partly be swollen or peeled. The durability of coating films has recently been improved in the field of construction exterior finish, but recoating cycle tends to be long; therefore, stains on the coating films have become noticeable.

As a method of preventing stains on a coating film, for example, there have hitherto been carried out various methods in which stains attached to a coating film are decomposed to be removed by adding a photocatalyst to a coating; stains are swollen to be removed by adding a hydrophilic component such as silicate to a coating, thereby allowing the surface of a coating film to fit in rain; the adherence of stains is suppressed by adding a resin component having a higher glass transition temperature to a coating, thereby hardening a coating film; and the adherence of stains is suppressed by adding inorganic fine particles such as silica to a coating, thereby hardening a coating film.

However, there is a problem that, when a photocatalyst is added to a coating, a resin component added to the coating is deteriorated by the action of the photocatalyst, and there is a problem that, when a hydrophilic component such as silicate is added to a coating, the water resistance of a coating film is lowered because of its high hydrophilic properties. On the other hand, there is a problem that, when a resin component having a higher glass transition temperature is added to a coating, the lowest temperature required for the formation of a coating film is raised and film forming properties are lowered at low temperatures, and there is a problem that, when inorganic fine particles such as silica are added to a coating, the water resistance of a coating film is lowered by a hydrophilic group on their surface. Accordingly, there has been desired a coating having water resistance, in addition to the durability of a coating film, and being hardly stained because of its low staining properties.

By the way, in glass products such as window glass and resin products such as films and sheets, there have been desired various materials which effectively block ultraviolet rays and infrared rays without damaging the transparency and hue of their resin components by coating and addition and which have antistatic properties. As such a material, for example, a resin composition containing composite fine particles made of zinc oxide type fine particles and a polymer has been proposed (see Japanese Patent Laid-open (Kokai) Publication No. 2003-54947).

However, fine particles described in Japanese Patent Laid-open (Kokai) Publication No. 2003-54947 are produced by keeping zinc oxide type fine particles and a polymer at a high temperature and forming a polymer layer on the surface of each of the fine particles, and therefore, a chemical bond does not exist between each of the zinc oxide type fine particles and the polymer. Accordingly, for example, when a resin formed article obtained by forming a resin composition containing such polymer-coated zinc oxide type fine particles is wetted with water, water enters between each of the zinc oxide type fine particles and the polymer layer, the polymer layer is partly swollen and peeled; therefore, there is a problem that the resin formed article has poor water resistance.

Also, metal oxides such as zinc oxide and titanium oxide have, for example, excellent ultraviolet blocking ability, and therefore, they have been used as an ultraviolet blocking agent in coating compositions and the like. For example, when an ultraviolet blocking agent is used in coating compositions, transparency is required. However, metal oxides usually have high refraction indices, and therefore, it is necessary that fine particles having a particle diameter of 100 nm or smaller are dispersed in coating compositions.

However, when the particle diameter of metal oxide is made small, their surface area is increased; therefore, aggregation easily occurs between metal oxide fine particles, and it is difficult to keep stably the dispersion state of coating compositions. Thus, various techniques of controlling the surface activity of metal oxide fine particles have been developed. In these techniques, a method of forming a polymer on the surface of each of metal oxide fine particles by polymerization in the presence of the metal oxide fine particles is very effective for improving the dispersibility and storage stability of metal oxide fine particles (see Japanese Patent Laid-open (Kokai) Publication Nos. Hei 9-194208, 2001-335721, and 2003-252916).

### SUMMARY OF THE INVENTION

Under these circumstances, it is an object of the present invention is to provide an additive, by which obtained are coating compositions capable of providing coating films having low staining properties and improved water resistance, as well as resin compositions capable of providing resin formed articles effectively blocking ultraviolet rays and infrared rays, without damaging the transparency and hue of their resin components, and having antistatic properties and water resistance.

The present inventor has made various studies, and as a result, has found that the above object can be attained by adding polymer-coated metal oxide fine particles in which the surface of each of metal oxide fine particles having a number-average particle diameter of 100 nm or smaller is coated with a polymer, to coating compositions and resin compositions, thereby completing the present invention.

Thus, the present invention provides polymer-coated metal oxide fine particles, comprising metal oxide fine particles having a number-average particle diameter of not smaller than 1 nm and not greater than 100 nm, a surface of each of the metal oxide fine particles being coated with a polymer.

The present inventor further has found that, when polymer-coated zinc oxide type fine particles comprising zinc oxide type fine particles having a number-average particle diameter of 100 nm or smaller, a surface of each of the zinc oxide type fine particles being coated with a polymer, which polymer is chemically bonded, through a coupling agent, to the surface of each of the zinc oxide type fine particles, are added to coating compositions and resin compositions, the properties of these coating compositions and resin compositions are improved.

Therefore, the polymer-coated metal oxide fine particles of the present invention may preferably be polymer-coated zinc oxide type fine particles comprising zinc oxide type fine particles having a number-average particle diameter of not smaller than 5 nm and not greater than 100 nm, a surface of each of the zinc oxide type fine particles being coated with a polymer, which polymer is chemically bonded, through a coupling agent, to the surface of each of the zinc oxide type fine particles. The coupling agent may preferably be a silane coupling agent. Also, the zinc oxide type fine particles may preferably comprise at least one metal element selected from a group consisting of metal elements belonging to groups 13 and 14 in the long-form periodic table. The metal element may preferably be aluminum and/or indium. Further, the polymer-coated zinc oxide type fine particles may preferably have a number-average particle diameter of not smaller than 10 nm and not greater than 200 nm.

These polymer-coated metal oxide fine particles are preferred for coating compositions and resin compositions. Accordingly, the present invention further provides a coating composition comprising the polymer-coated metal oxide fine particles and a binder component capable of forming a coating film in which the polymer-coated metal oxide fine particles are dispersed; a resin composition comprising the polymer-coated metal oxide fine particles and a resin component capable of forming a continuous phase in which the polymer-coated metal oxide fine particles are dispersed; and a resin formed article obtained by forming the resin composition in one shape selected from a plate, a sheet, a film, and a fiber.

The present invention further provides a dispersion of polymer-coated metal oxide fine particles, comprising the polymer-coated metal oxide fine particles dispersed in a dispersion medium.

In the dispersion of polymer-coated metal oxide fine particles of the present invention, the polymer-coated metal oxide fine particles may preferably be polymer-coated zinc oxide type fine particles, comprising zinc oxide type fine particles having a number-average molecular weight of not smaller than 5 nm and not greater than 100 nm, each of surface of the zinc oxide type fine particles being coated with a polymer, which polymer is formed by emulsion polymerization using a polymerizable monomer and a radical initiator.

It is another object of the present invention to provide an aqueous dispersion of polymer-coated metal oxide fine particles useful as an additive capable of providing, for example, when used in coating compositions, coating films having remarkably improved water resistance and weather resistance; and a process for its production.

The present inventor has made various studies, and as a result, has found that the above object is attained by adding, to coating compositions and resin compositions, an aqueous dispersion which contains polymer-coated metal oxide fine particles comprising metal oxide fine particles having a number-average particle diameter of 100 nm or smaller, a surface of each of the metal oxide fine particles being coated with a polymer, which polymer is formed by emulsion polymerization using a polymerizable monomer and a radical initiator, thereby completing the present invention.

Thus, the present invention provides an aqueous dispersion of polymer-coated metal oxide fine particles, comprising the polymer-coated metal oxide fine particles (i.e., the polymer-coated metal oxide fine particles obtained by coating each of surface of metal oxide fine particles having a number-average particle diameter of not smaller than 1 nm and not greater than 100 nm with a polymer), the polymer being formed by emulsion polymerization using a polymerizable monomer and a radical initiator.

The present inventor further has found that the properties of these coating compositions and resin compositions are improved by adding, to coating compositions and resin compositions, an aqueous dispersion of polymer-coated metal oxide fine particles, wherein a ratio of a total amount of residual monomer to a total amount of polymer coating is not greater than 0.5% by mass.

Therefore, in the aqueous dispersion of polymer-coated metal oxide fine particles of the present invention, a ratio of a total amount of residual monomer to a total amount of polymer coating may preferably be 0.5% by mass or smaller. Also, the metal oxide fine particles may preferably comprise zinc oxide type fine particles, titanium oxide fine particles, silica fine particles, silica-coated zinc oxide fine particles, or silica-coated titanium oxide fine particles. Further, the metal oxide fine particles may preferably be treated with a coupling agent in advance of emulsion polymerization.

The aqueous dispersion of polymer-coated metal oxide fine particles is preferred for coating compositions and resin compositions. Thus, the present invention further provides a coating composition comprising the aqueous dispersion of polymer-coated metal oxide fine particles; a resin composition comprising the aqueous dispersion of polymer-coated metal oxide fine particles; and a resin formed article obtained by forming the resin composition in one shape selected from a plate, a sheet, a film, and a fiber.

Further, the present invention provides a process for producing an aqueous dispersion of polymer-coated metal oxide fine particles, comprising carrying out emulsion polymerization using a polymerizable monomer and a radical initiator in a presence of metal oxide fine particles having a number-average particle diameter of not smaller than 1 nm and not greater than 100 nm, in which case two or more radical initiators having different half-life periods are used as radical initiators; and a process for producing an aqueous dispersion of polymer-coated metal oxide fine particles, comprising carrying out emulsion polymerization using a polymerizable monomer and a radical initiator in a presence of metal oxide fine particles having a number-average particle diameter of not smaller than 1 nm and not greater than 100 nm, in which case one part of the radical initiator is added to a reaction system, and after an interval, the other part of the radical initiator is added to the reaction system.

In particular, when the polymer-coated zinc oxide type fine particles in the polymer-coated metal oxide fine particles of the present invention are used, there can be obtained containing compositions providing coating films having low staining properties and improved water resistance and resin compositions effectively blocking ultraviolet rays and infrared rays without damaging the transparency and hue of their resin components and providing resin formed articles having antistatic properties and water resistance.

Also, when the aqueous dispersion of polymer-coated metal oxide fine particles of the present invention is used, there can be obtained coating compositions effectively blocking ultraviolet rays and providing coating films having remarkably improved water resistance and weather resistance and resin compositions providing resin formed articles having light resistance, water resistance, and weather resistance without damaging the transparency and hue of base resins.

### DETAILED DESCRIPTION OF THE INVENTION

The present invention will be explained below in detail; however, the scope of the present invention is not limited to these explanations at all, and those other than the following examples can also be employed by making appropriate modifications or variations within a scope not damaging the gists of the present invention.

<<Polymer-Coated Metal Oxide Fine Particles>>

The polymer-coated metal oxide fine particles of the present invention comprise metal oxide fine particles having a number-average particle diameter of not smaller than 1 nm and not greater than 100 nm, a surface of each of metal oxide fine particles being coated with a polymer.

In the present invention, examples of the metal oxide fine particles may include fine particles of metal oxides such as magnesium oxide, calcium oxide, cerium oxide, titanium oxide (e.g., utile type, anatase type, brookite type), zirconium oxide, iron oxide, zinc oxide, aluminum oxide, and silica; composite metal oxides such as composite oxides of zinc oxide and titanium oxide, composite oxides of aluminum oxide and magnesium oxide, and composite oxides of calcium oxide and zirconium oxide; and silica-coated metal oxides such as silica-coated zinc oxide and silica-coated titanium oxide. In the present invention, the term “metal” is a concept including silicon, and “silica” is included in the category of metal oxides. These metal oxide fine particles may be used alone, or two or more kinds of these metal oxide fine particles may also be used in combination. In these metal oxide fine particles, preferred are zinc oxide type fine particles, titanium oxide (rutile type, anatase type, and brookite) fine particles, silica fine particles, silica-coated zinc oxide fine particles and silica-coated titanium oxide fine particles.

These metal oxide fine particles may be prepared per se by any of the heretofore known methods or commercially available products may be used. When they are prepared per se, the zinc oxide type fine particles can be prepared by the method described later. The silica-coated zinc oxide fine particles and silica-coated titanium oxide can be prepared by the method described in the following Examples or, for example, methods described in Japanese Patent Laid-open (Kokai) Publication Nos. Hei 11-302015 and 2003-252916. On the other hand, when commercially available products are used, examples of the zinc oxide type fine particles may include “FINEX-25”, “FINEX-50”, and “FINEX-75”, available from by Sakai Chemical Industry Co., Ltd.; “NANOZINC 60”, available from The Honjo Chemical Corporation; and “ZINCOX SUPER F2”, available form Hakusui Tech Co., Ltd. Examples of the titanium oxide fine particles may include “NTB NANOTITANIA”, available from Showa Denko K.K.; “Titanium Oxide Ultra Fine Particles TTO-V series”, available from Ishihara Sangyo Kaisha Ltd.; and “STR-100C”, available from Sakai Chemical Industry Co., Ltd. Examples of the silica-coated zinc oxide fine particles may include “NANOFINE-50A”, available from Sakai Chemical Industry Co., Ltd.; “MAXLIGHT ZS-032”, available from Showa Denko K.K.; and “SIH-20 ZnO-350”, available from Sumitomo Osaka Cement Co., Ltd. Examples of the silica-coated titanium oxide fine particles may include “MAXLIGHT TS-01”, “MAXLIGHT TS-04”, “MAXLIGHT TS-043”, and “MAXLIGHT F-TS20”, available from Showa Denko K.K.

In the present invention, the term “zinc oxide type fine particles” means fine particles which contain zinc oxide as a main component, and if necessary, further contain at least one metal element selected from the group consisting of metal elements belonging to groups 13 and 14 in the long-form periodic table, and which have the crystal structure of zinc oxide (ZnO) when observed by X-ray crystallography. The phrase “when observed by X-ray crystallography” as used herein means that the X-ray diffraction pattern of the fine particles is substantially the same as the diffraction pattern of zinc oxide (ZnO) powder. As the crystal structure of zinc oxide (ZnO), it is not particularly limited, but there have been known, for example, a hexagonal wurtzite structure, a cubic sodium chloride structure, and a cubic face-centered structure, and zinc oxide may have any of these crystal structures.

The content of zinc atom in the zinc oxide type fine particles may preferably be not lower than 80% and not higher than 100%, more preferably not lower than 85% and not higher than 99.9%, and still more preferably not lower than 90% and not higher than 99.5%, at a ratio of the zinc atom number to the total metal atom number. When the content of zinc atom is lower than 80%, uniform fine particles in which their particle shape, particle diameter, and the like are controlled may hardly be obtained.

Examples of the metal element belonging to group 13 in the long-form periodic table, if necessary, added to zinc oxide may include boron, aluminum, gallium, indium, and thallium. Examples of the metal element belonging to group 14 in the long-form periodic table, if necessary, added to zinc oxide may include silicon, germanium, tin, and lead. Incidentally, boron, silicon, and germanium are usually not metal elements and are called as metalloid elements; however, in the present invention, they are included in the category of metal elements. These metal elements may be used alone, or two or more kinds of these metal elements may also be used in combination. In these elements, aluminum and indium are preferred.

Zinc oxide can effectively block ultraviolet rays, but cannot block near infrared rays. On the other hand, oxides of metal elements belonging to groups 13 and 14 in the long-form periodic table cannot also block near infrared rays. However, when at least one metal element belonging to group 13 or 14 in the long-form periodic table is added to zinc oxide to form a crystalline coprecipitate containing zinc oxide and the metal element(s), near infrared rays can effectively be blocked by synergy action between zinc and the metal element(s) added. The phrase “effectively block ultraviolet rays” as used herein means absorption properties having an absorption end at a wavelength of 360 nm or longer for ultraviolet rays, and the phrase “effectively block infrared rays” as used herein means blocking properties having a cutoff wavelength at 2.0 μm or shorter for infrared rays.

In the above case, it is important that the zinc oxide type fine particles are crystalline coprecipitates. In the case where the zinc oxide type fine particles are non-crystalline, even if they are coprecipitate, they cannot block near infrared rays, and the zinc oxide type fine particles crystallized by the calcination of non-crystalline coprecipitates cannot, although they are crystalline, block near infrared rays. Also, when at least one metal element belonging to group 13 or 14 in the long-form periodic table is added to zinc oxide, zinc oxide can be provided with electrical conductivity; therefore, the zinc oxide type fine particles obtained become to have antistatic properties.

The shape of the metal oxide fine particles is not particularly limited, but it may be, for example, granules such as spherical, ellipsoidal, and polygonal; flakes such as scale-like and (hexagonal) plate like; a needle shape, a columnar shape, a rod shape, a tubular shape, and the like are mentioned. These shapes may exist alone, or two or more kinds of these shapes may exist in combination. In these shapes, preferred are granules such as spherical, ellipsoidal, and polygonal.

The number-average particle diameter of the metal oxide fine particles may usually be not smaller than 1 nm and not greater than 100 nm, preferably not smaller than 5 nm and not greater than 80 nm, more preferably not smaller than 8 nm and not greater than 60 nm, and still more preferably not smaller than 10 nm and not greater than 50 nm. When the number-average particle diameter of the metal oxide fine particles is smaller than 1 nm, the metal oxide fine particles may cause aggregation to form a high-order structure; therefore, it is difficult to obtain the polymer-coated metal oxide fine particles having a specific number-average particle diameter. In contrast, when the number-average particle diameter of the metal oxide fine particles is greater than 100 nm, the number-average particle diameter of the polymer-coated metal oxide fine particles may become increased, and for example, when they are added to coating compositions and resin compositions, the transparency of base resins may be deteriorated.

In the present invention, the number-average particle diameter of the metal oxide fine particles is a value measured by the method described in the following Examples. The term “primary particle diameter” as used herein means the particle diameter of the shortest portion of a primary particle, unless otherwise noted, and the term “the particle diameter of the shortest portion” as used herein means the shortest length passing the center of a primary particle. For example, when the shape of the metal oxide fine particles is spherical, the particle diameter of the shortest portion means the diameter of the sphere, and when the shape of the metal oxide fine particles is ellipsoidal, the particle diameter of the shortest portion means the short diameter in the short diameter and long diameter. When the shape of the metal oxide fine particles is polygonal, the particle diameter of the shortest portion means the shortest length passing through the center of a primary particle, and when the shape of the metal oxide fine particles is flaky such as scale-like and (hexagonal) planar, the particle diameter of the shortest portion means the shortest length (i.e., thickness) passing through the center of a primary particle in the direction (i.e., the thickness direction) perpendicular to the in-plane direction. When the shape of the metal oxide fine particle is a needle shape, a columnar shape, a rod shape, a tubular shape, or the like, the particle diameter of the shortest portion means the shortest length passing through the center of a primary particle, which shortest length is measured in a direction perpendicular to the length direction.

In the polymer-coated metal oxide fine particles of the present invention, the surface of each of the metal oxide fine particles is coated with a polymer. The phrase “coated with a polymer” as used herein means that the whole surface of each of the metal oxide fine particles is coated with a polymer in seamless manners. Incidentally, the polymer coating the surface of each of the metal oxide fine particles is referred to sometimes as the “coating polymer”. The coating polymer is not particularly limited, so long as it can cover the surface of each of the metal oxide fine particles with the polymer by the emulsion polymerization of a polymerizable monomer in the presence of the metal oxide fine particles, preferably the metal oxide fine particles treated with a coupling agent in an aqueous medium, but it may includes (meth)acrylic-type polymers, styrene-type polymers, vinyl acetate-type polymers, vinyl chloride-type polymers, vinylidene-type polymers, and their copolymers. These polymers may be used alone, or two or more kinds of these polymers may also be used in combination. In these polymers, preferred are (meth)acrylic-type polymers, styrene-type polymers, and their copolymers.

The polymer-coated metal oxide fine particles may be coated with a single polymer or may be coated with two or more kinds of polymers. Also, the polymer-coated metal oxide fine particles may be composed of one kind of fine particles with the same coating polymer or may be composed of two or more kinds of fine particles with different coating polymers.

When the metal oxide fine particles treated with a coupling agent in advance of emulsion polymerization are used, the coating polymer is chemically bonded, through the coupling agent, to the surface of each of the metal oxide fine particles in the polymer-coated metal oxide fine particles obtained. The term “chemical bond” as used herein mainly means a covalent bond, but for example, since a covalent bond between different atoms has occasionally the characteristic of an ionic bond in a greater or less degree, the “chemical bond” as used in the present invention may further include a case where the covalent bond and the ionic bond are in resonance with each other. However, the “chemical bond” as used in the present invention does not include weak bonds which act between molecules, such as static attractive forces, dispersion forces, hydrogen bonds, and charge-transfer forces. Also, the phrase “chemically bonded, through a coupling agent, to . . . ” as used herein means that a hydroxyl group existing on the surface of each of the metal oxide fine particles is chemically bonded to the coupling agent and the coupling agent is chemically bonded to the coating polymer.

When the metal oxide fine particles treated with a coupling agent in advance of emulsion polymerization are used, the polymer-coated metal oxide fine particles exhibits excellent water resistance because the coating polymer is chemically bonded, through the coupling agent, to the surface of each of the metal oxide fine particles, so that the coating polymer is firmly attached to each of the metal oxide fine particles, thereby not allowing rain water and the like to enter between each of the metal oxide fine particles and the coating polymer.

In the present invention, the number-average particle diameter of the polymer-coated metal oxide fine particles may preferably be not smaller than 10 nm and not greater than 200 nm, more preferably not smaller than 15 nm and not greater than 150 nm, and still more preferably not smaller than 20 nm and not greater than 100 nm. When the number-average particle diameter of the polymer-coated metal oxide fine particles is smaller than 10 nm, the effect of improving the water resistance and weather resistance of coating films may be small, for example, in the case where the polymer-coated metal oxide fine particles are added to coating compositions. In contrast, when the number-average particle diameter of the polymer-coated metal oxide fine particles is greater than 200 nm, the transparency of base resins may be deteriorated, for example, in the case where the polymer-coated metal oxide fine particles are added to coating compositions and resin compositions.

In the present invention, the number-average particle diameter of the polymer-coated metal oxide fine particles is a value measured by the method described in the following Examples, but the “primary particle diameter” has the meaning similarly defined as the case of the metal oxide fine particles, unless otherwise noted. However, the polymer-coated metal oxide fine particles of the present invention may include a case where each of primary particles (i.e., single fine particles) of the metal oxide fine particles is coated with a polymer and a case where each of secondary particles (i.e., fine particle groups in which two or more fine particles are aggregated) is coated with a polymer, and both the polymer-coated metal oxide fine particles are primary particles.

<Polymer-Coated Zinc Oxide Type Fine Particles>

In the present invention, the polymer-coated metal oxide fine particles may preferably be polymer-coated zinc oxide type fine particles comprising zinc oxide type fine particles having a number-average particle diameter of not smaller than 5 nm and not greater than 100 nm, a surface of each of the zinc oxide type fine particles being coated with a polymer, which polymer is chemically bonded, through a coupling agent, to the surface of each of the zinc oxide type fine particles. In this case, the “polymer-coated metal oxide fine particles” may be referred to sometimes as the “polymer-coated zinc oxide type fine particles”.

In the polymer-coated zinc oxide type fine particles of the present invention, the zinc oxide type fine particles may preferably comprise at least one metal element selected from the group consisting of metal elements belonging to groups 13 and 14 in the long-form periodic table. The metal element may preferably be aluminum and/or indium.

The number-average particle diameter of the zinc oxide type fine particles may usually be not smaller than 5 nm and not greater than 100 nm, preferably not smaller than 6 nm and not greater than 80 nm, more preferably not smaller than 8 nm and not greater than 60 nm, and still more preferably not smaller than 10 nm and not greater than 50 nm. When the number-average particle diameter of the zinc oxide type fine particles is smaller than 5 nm, the zinc oxide type fine particles may cause aggregation to form a high-order structure; therefore, it is difficult to obtain the polymer-coated zinc oxide type fine particles having a specific number-average particle diameter. In contrast, when the number-average particle diameter of the zinc oxide type fine particles is greater than 100 nm, the number-average particle diameter of the polymer-coated zinc oxide type fine particles may become increased, and for example, when they are added to coating compositions and resin compositions, the transparency of base resins may be deteriorated.

Examples of the coupling agent combining each of the zinc oxide type fine particles with a polymer may include silane coupling agents and titanate type coupling agents, both having various functional groups. In these coupling agents, silane coupling agents are preferred. The specific examples of the silane coupling agents may include various silane coupling agents listed in the column entitled “Process for producing polymer-coated metal oxide fine particles”. These silane coupling agents may be used alone, or two or more kinds of these silane coupling agents may also be used in combination. In these silane coupling agents, preferred are silane coupling agents having at least one vinyl group and silane coupling agents each having at least one (meth)acryloyl group.

The number-average particle diameter of the polymer-coated zinc oxide type fine particles may preferably be not smaller than 10 nm and not greater than 200 nm, more preferably not smaller than 15 nm and not greater than 150 nm, and still more preferably not smaller than 20 nm and not greater than 100 nm. When the number-average particle diameter of the polymer-coated zinc oxide type fine particles is smaller than 10 nm, the effect of exhibiting the low staining properties of coating films may be small, for example, in the case where the polymer-coated zinc oxide type fine particles are added to coating compositions. In contrast, when the number-average particle diameter of the polymer-coated zinc oxide type fine particles is greater than 200 nm, the transparency of base resins may be deteriorated, for example, in the case where the polymer-coated zinc oxide type fine particles are added to coating compositions and resin compositions.

The zinc oxide type fine particles can be prepared by the method described later. Also, the polymer-coated zinc oxide type fine particles can be prepared by the method described later in the same manner as the other polymer-coated metal oxide fine particles.

The polymer-coated zinc oxide type fine particles are used, for example, for dispersions of the polymer-coated zinc oxide type fine particles of the present invention, coating compositions, and resin compositions.

<Dispersion of Polymer-Coated Zinc Oxide Type Fine Particles>

The dispersion of polymer-coated zinc oxide type fine particles of the present invention comprises the polymer-coated zinc oxide type fine particles dispersed in a dispersion medium.

In the present invention, the polymer-coated zinc oxide type fine particles may preferably be polymer-coated zinc oxide type fine particles comprising zinc oxide type fine particles having a number-average particle diameter of not smaller than 5 nm and not greater than 100 nm, a surface of each of the zinc oxide type fine particles being coated with a polymer, which polymer is formed by emulsion polymerization using a polymerizable monomer and a radical initiator.

The dispersion medium may appropriately be selected depending on the intended use of the dispersion, the kind of a coating polymer, and the like, and it is not particularly limited, but examples thereof may include organic solvents such as alcohols, aliphatic and aromatic carboxylic acid esters, ketones, ethers, ether esters, aliphatic and aromatic hydrocarbons, and halogenated hydrocarbons; water; mineral oils, vegetable oils, wax oils, and silicone oils. These dispersion mediums may be used alone, or two or more kinds of these dispersion mediums may also be used in combination. When water is used as a dispersion medium, the resultant dispersion can be used as it is without removing the dispersion medium after polymerization reaction; therefore, it is economically advantageous.

The content of polymer-coated zinc oxide type fine particles in the dispersion of polymer-coated zinc oxide type fine particles of the present invention may preferably be, for example, not lower than 1% by mass and not higher than 80% by mass, more preferably not lower than 5% by mass and not higher than 70% by mass, and still more preferably not lower than 10% by mass and not higher than 60% by mass, relative to the total mass of the dispersion. When the content of polymer-coated zinc oxide type fine particles is lower than 1% by mass, a dispersion medium may be used more than necessary and production cost may be increased. In contrast, when the content of polymer-coated zinc oxide type fine particles is higher 80% by mass, the polymer-coated zinc oxide type fine particles may cause aggregation to form a high-order structure; therefore, dispersibility may be lowered.

The dispersion of polymer-coated zinc oxide type fine particles of the present invention can contain, depending on the intended use, at least one additive, such as thermal stabilizers, antioxidants, light stabilizers, plasticizers, and dispersants, at their ordinary addition amounts.

A method of dispersing the polymer-coated zinc oxide type fine particles in a dispersion medium may appropriately be selected from the hitherto known dispersion methods, and it is not particularly limited, but examples thereof may include methods using a stirrer, a ball mill, a sand mill, an ultrasonic homogenizer, and the like.

Also, when the polymer-coated zinc oxide type fine particles are in the form of a dispersion and the polymer-coated zinc oxide type fine particles are dispersed in a different dispersion medium, there can be used a method in which the polymer-coated zinc oxide type fine particles are separated, for example, by filtration, centrifugal separation, or evaporation of the dispersion medium, and then mixed with a dispersion medium to be replaced, followed by dispersing the mixture using any of the methods described above, or what is called a solvent replacement method with heating, in which the dispersion is heated so that part or all of the dispersion medium constituting the dispersion is evaporated and distilled out, while a dispersion medium to be replaced is mixed therein.

The dispersion of polymer-coated zinc oxide type fine particles of the present invention can be used, for example, as a material for coating compositions and resin compositions.

<Preparation of Zinc Oxide Type Fine Particles>

The zinc oxide type fine particles can be prepared as a crystalline coprecipitate by keeping a mixture in which a zinc component and a monocarboxylic acid are dissolved or dispersed in a medium containing at least one alcohol, at a temperature of not lower than 100° C. and not higher than 300° C. In the case where at least one metal element selected from the group consisting of metal elements belonging to groups 13 and 14 in the long-form periodic table is added, a metal component including the metal element, such as a single metal, an alloy, or a metal compound (hereinafter collectively referred to sometimes as the “metal compound”), may coexist when the above mixture is kept at a temperature of not lower than 100° C. and not higher than 300° C. The zinc component is converted into crystalline zinc oxide fine particles by heating the above mixture containing a monocarboxylic acid and an alcohol. However, when a metal compound coexists in the mixture, fine particles can be obtained, which contain the metal element but have the crystal structure of zinc oxide when observed by X-ray crystallography.

Examples of the zinc component may include metal zinc such as zinc dust; zinc oxide such as zinc white; inorganic such as zinc hydroxide and basic zinc carbonate; and mono- or di-carboxylates such as zinc acetate, zinc octylate, zinc stearate, zinc oxalate, zinc lactate, zinc tartrate, and zinc naphthenate. These zinc components may be used alone, or two or more kinds of these zinc components may also be used in combination. In these zinc components, metal zinc such as zinc dust, zinc oxide such as zinc white, zinc hydroxide, basic zinc carbonate, and zinc acetate are preferred because these zinc components are not expensive and can easily be handled, and zinc oxide, zinc hydroxide, and zinc acetate are particularly preferred because these zinc components do not substantially contain impurities inhibiting the formation reaction of crystalline coprecipitates and the size and shape of the zinc oxide type fine particles can easily be controlled.

The amount of zinc component to be used may preferably be not smaller than 0.1% by mass and not greater than 95% by mass, more preferably not smaller than 0.5% by mass and not greater than 50% by mass, and still more preferably not smaller than 1% by mass and not greater than 30% by mass, in terms of zinc oxide, relative to a total amount of medium including the zinc component, a monocarboxylic acid, and at least one alcohol. When the amount of zinc component to be used is smaller than 0.1% by mass, productivity may be lowered. In contrast, when the amount of zinc component to be used is greater than 95% by mass, the aggregation of fine particles may easily occurs and the fine particles having excellent dispersibility and narrow particle size distribution cannot be obtained.

Examples of the monocarboxylic acid may include saturated aliphatic acids (saturated monocarboxylic acids) such as formic acid, acetic acid, propionic acid, butyric acid, isobutyric acid, caproic acid, caprylic acid, lauric acid, myristic acid, palmitic acid, and stearic acid; unsaturated aliphatic acids (unsaturated monocarboxylic acids) such as acrylic acid, methacrylic acid, crotonic acid, oleic acid, and linolenic acid; cyclic saturated monocarboxylic acids such as cyclohexanecarboxylic acid; aromatic monocarboxylic acids such as benzoic acid, phenylacetic acid, and toluic acid; the anhydrides of the above monocarboxylic acids, such as acetic anhydride; halogen-containing monocarboxylic acids such as trifluoroacetic acid, monochloroacetc acid, and o-chlorobenzoic acid; and hydroxyl group-containing monocarboxylic acids such as lactic acid. These monocarboxylic acids may be used alone, or two or more kinds of these monocarboxylic acids may also be used in combination. In these monocarboxylic acids, saturated aliphatic acids having a boiling point of 200° C. or lower at 1 atmospheric pressure, for example, formic acid, acetic acid, propionic acid, butyric acid, and isobutyric acid are preferred because the precipitation reaction of the zinc oxide type fine particles can strictly be controlled.

Examples of the alcohol to be used for the medium may include monohydric alcohols such as a aliphatic monohydric alcohols (e.g., methanol, ethanol, isopropyl alcohol, n-butanol, t-butyl alcohol, stearyl alcohol), aliphatic unsaturated monohydric alcohols (e.g., allyl alcohol, crotyl alcohol, propargyl alcohol), alicyclic monohydric alcohols (e.g., cyclopentanol, cyclohexanol), aromatic monohydric alcohols (e.g., benzyl alcohol, cinnamyl alcohol, methylphenylcarbinol), and heterocyclic monohydric alcohols (e.g., furfuryl alcohol); glycols such as aliphatic glycols having at least one aromatic ring (e.g., hydrobenzoin, benzpinacol, phthalyl alcohol), alicyclic glycols (e.g., cyclopentane-1,2-diol, cyclohexane-1,2-diol, cyclohexane-1,4-diol), and polyoxyalkylene glycols (e.g., polyethylene glycol, polypropylene glycol); monoethers and monoesters of the above glycols, such as ethyleneglycol monomethyl ether, ethyleneglycol monobutyl ether, triethyleneglycol monomethyl ether, and ethyleneglycol monoacetate; aromatic diols such as hydroquinone, resorcin, and 2,2-bis(4-hydroxyphenyl)propane, and monoethers and monoesters thereof; trihydric alcohols such as glycerin, and monoethers, monoesters, diethers, and diesters thereof. These alcohols may be used alone, or two or more kinds of these alcohols may also be used in combination.

The amount of alcohol to be used in the medium is not particularly limited, but may preferably be not lower than 1 and not higher than 100, more preferably not lower than 5 and not higher than 80, and still more preferably not lower than 10 and not higher than 50, by the molar ratio of alcohol to zinc atom derived from the zinc component, in order to carry out the formation reaction of zinc oxide type fine particles for a short time. When the amount of alcohol to be used is lower than 1 by the above molar ratio, zinc oxide type fine particles having excellent crystallinity cannot be obtained, and fine particles having excellent uniformity of their shape and particle diameter and having excellent dispersibility cannot be obtained. In contrast, when the amount of alcohol to be used is higher than 100 by the above molar ratio, the alcohol may be used more than necessary and production cost may be increased.

Examples of the medium containing at least one alcohol may include a medium consisting only of the alcohol; a mix solvent of the alcohol with water; and a mixed solvent of the alcohol with an organic solvent other than the alcohol, such as ketones, esters, aromatic hydrocarbons, and ethers. The content of alcohol may preferably be not lower than 5% by mass and not higher than 100% by weight, more preferably not lower than 30% by mass and not higher than 100% by weight, and still more preferably not smaller than 60% by mass and not higher than 100% by weight, relative to a total amount of mediums. When the content of alcohol is smaller than 5% by mass, there cannot be obtained fine particles having excellent crystallinity, excellent uniformity of their shape and particle diameter, and excellent dispersibility.

Examples of the metal compound containing at least one metal element to be added may include metals such as single metals and alloys; and compounds containing at least one trivalent or tetravalent metal element, such as oxides, hydroxides, inorganic salts, e.g., (basic) carbonates, nitrates, sulfates, halides (e.g., fluorides, chlorides); carboxylates such as acetates, propionates, butyrates, and laurates; metal alkoxides; metal chelate compounds having, as at least one ligand, β-diketones, hydroxycarboxylic acids, keto esters, keto alcohols, amino alcohols, glycols, quinolines, and the like. Incidentally, in the case of metal elements capable of having two or more numbers of valences, such as indium and thallium, at least one kind of metal compound selected from the group consisting of metal compounds containing at least one metal with a low valence capable of finally changing to trivalent or tetravalent is used at the step in which the zinc oxide type fine particles are formed.

When boron is used as a metal element belonging to group 13 in the long-form periodic table, examples of a metal compound containing boron may include boron trioxide, boric acid, boron oxalate, boron trifluoride diethyl ether complex, boron trifluoride monoethylamine complex, trimethyl borate, triethyl borate, triethoxy borane, and tri-n-butyl borate. These compounds may be used alone, and two or more kinds of these compounds may also be used in combination.

When aluminum is used as a metal element belonging to group 13 in the long-form periodic table, examples of a metal compound containing aluminum may include aluminum, aluminum hydroxide, aluminum oxide, aluminum chloride, aluminum fluoride, aluminum nitrate, aluminum sulfate, basic aluminum acetate, aluminum trisacetyl-acetonate, aluminum trimethoxide, aluminum tirethoxide, aluminum triisopropoxide, aluminum tri-n-butoxide, acetoalkoxyaluminum diisopropylate, aluminum laurate, aluminum stearate, diisopropoxy-aluminum stearate, and ethylaetatealuminum diisopropylate. These compounds may be used alone, or two or more kinds of these compounds may also be used in combination.

When gallium is used as a metal element belonging to group 13 in the long-form periodic table, examples of a metal compound containing gallium may include gallium, gallium (III) hydroxide, gallium (III) oxide, gallium (III) chloride, gallium (III) bromide, gallium (III) nitrate, gallium (III) sulfate, gallium ammonium sulfate, gallium triethoxide, and gallium tri-n-butoxide. These compounds may be used alone, or two or more kinds of these compounds may also be used in combination.

When indium is used as a metal element belonging to group 13 in the long-form periodic table, examples of a metal compound containing indium may include indium, indium (III) oxide, indium (III) hydroxide, indium (III) sulfate, indium (III) chloride, indium (III) fluoride, indium (III) iodide, indium isopropoxide, indium (III) acetate, indium triethoxide, and indium tri-n-butoxide. These compounds may be used alone, or two or more kinds of these compounds may also be used in combination.

When thallium is used as a metal element belonging to group 13 in the long-form periodic table, examples of a metal compound containing thallium may include thallium, thallium (I) oxide, thallium (III) oxide, basic gallium (I) hydroxide, thallium (I) chloride, thallium (I) iodide, thallium (I) nitrate, thallium (I) sulfate, thallium (I) hydrogensulfate, basic thallium (I) sulfate, thallium (I) acetate, thallium (I) formate, thallium (I) malonate, thallium (III) chloride, thallium (III) nitrate, thallium (III) carbonate, and thallium (III) sulfate. These compounds may be used alone, or two or more kinds of these compounds may also be used in combination.

When silicon is used as a metal element belonging to group 14 in the long-form periodic table, examples of a metal compound containing silicon may include silicon; silicon dioxide; alkoxysilanes such as tetraalkoxysilanes (e.g., tetramethoxysilane, tetraethoxysilane, tetrabuthoxysilane), alkylalkoxysilanes (e.g., methyltrimethoxysilane, trimethoxysilane, 3-chloropropyltrimethoxysilane, 3-mercaptopropyl-trimethoxysilane, 3-glycidoxypropyltrimethoxy-silane, 3-(2-aminoethylaminopropyl)trimethoxy-silane, phenyltrimethoxysilane, diethoxydimethyl-silane, trimethylethoxysilane, hydroxyethyl-triethoxysilane), phenyltrimethoxysilane, benzyltriethoxysilane, γ-amniopropyltriethoxy-silane, N-β-(amnioethyl)-γ-aminopropyltrimethoxy-silane, γ-glycidoxypropyltrimethoxysilane, γ-methacryloxypropyltrimethoxysilane, γ-mercapto-propyltrimethoxysilane, γ-chloropropyltrimethoxy-silane, and stearyltrimethoxysilane; chlorosilanes such as tetrachlorosilane, trichlorosilane, and methyltrichlorosilane; and acetoxysilanes such as triacetoxysilane. These compounds may be used alone, or two or more kinds of these compounds may also be used in combination.

When germanium is used as a metal element belonging to group 14 in the long-form periodic table, examples of a metal compound containing germanium may include germanium, germanium (IV) oxide, germanium (IV) chloride, germanium (IV) iodide, germanium (IV) acetate, germanium (IV) chloride bipyridyl complex, β-carboxyethyl-germanium sesquioxide, and germanium (IV) ethoxide. These compounds may be used alone, or two or more kinds of these compounds may also be used in combination.

When tin is used as a metal element belonging to group 14 in the long-form periodic table, examples of a metal compound containing tin may include tin, tin (IV) oxide, tin (IV) chloride, tin (IV) acetate, di-n-butyltin dichloride, di-n-butyltin dilaurate, di-n-butyltin malate (polymer), di-n-butyltin oxide, di-n-methyltin dichloride, di-n-octyltin malate (polymer), di-n-octyltin oxide, diphenyltin dichloride, di-n-butyltin oxide, tetra-n-butyltin, mono-n-butyltin oxide, tetra-n-butyltin, stannic (II) oxalate, tri-n-butyltin acetate, tri-n-butyltin ethoxide, trimethyltin chloride, triphenyltin acetate, triphenyltin hydroxide, tin tetraethoxide, and tin tetra-n-butoxide. These compounds may be used alone, or two or more kinds of these compounds may also be used in combination.

When lead is used as a metal element belonging to group 14 in the long-form periodic table, examples of a metal compound containing lead may include lead, lead (IV) acetate, lead (IV) chloride, lead (IV) fluoride, lead (IV) oxide, lead (II+IV) oxide, and lead (II) oxalate. These compounds may be used alone, or two or more kinds of these compounds may also be used in combination.

As the oxides and hydroxides of the metal element to be added, although powder may be used, colloidal metal oxides, such as alumina sol and silica sol, and aqueous sols and alcoholic sols of metal hydroxides, can be used.

The preparation of the zinc oxide type fine particles may includes (1) a step of preparing a mixture containing a zinc component and a monocarboxylic acid, (2) a step of mixing the resultant mixture with a medium containing at least one alcohol to prepare a mixture in which the zinc component and the monocarboxylic acid are dissolved or dispersed in the medium containing at least one alcohol by, and (3) a step of keeping the resultant mixture at a temperature of not lower than 100° C. and not higher than 300° C. to obtain the zinc oxide type fine particles made of crystalline coprecipitates of zinc oxide. When at least one metal element selected from the group consisting of metal elements belonging to groups 13 and 14 in the long-form periodic table is added, a metal compound containing the metal element may be added to the mixture in any one or in two or more of the above steps (1), (2), and (3).

The zinc oxide type fine particles obtained are in the form of a dispersion in which the zinc oxide type fine particles are dispersed in the medium containing at least one alcohol, but if necessary, it may be converted to the form of powder by being separated from the medium, washed with a solvent, and then dried. The method of separating the zinc oxide type fine particles may appropriately be selected from the heretofore known separation methods, and it is not particularly limited, but examples thereof may include filtration, decantation, and centrifugal separation. The solvent for washing the zinc oxide type fine particles is not particularly limited, so long as it is a solvent which can easily be removed at the time of drying after washing, but examples thereof may include alcohols such as methyl alcohol, ethyl alcohol, and isopropyl alcohol; ethers such as diethyl ether; esters such as ethyl acetate; ketones such as acetone; and hydrocarbons such as benzene and hexane. The method of drying the zinc oxide type fine particles may appropriately be selected from the heretofore known drying methods, and it is not particularly limited, but examples thereof may include natural drying, heating drying, reduced-pressure drying, and spray drying.

The zinc oxide type fine particles thus obtained can be used for the production of the polymer-coated zinc oxide type fine particles of the present invention or the aqueous dispersion thereof.

<<Process for Producing Polymer-Coated Metal Oxide Fine Particles>>

The polymer-coated metal oxide fine particles of the present invention can be produced by carrying out the emulsion polymerization of a polymerizable monomer in the presence of metal oxide fine particles, preferably metal oxide fine particles treated with a coupling agent.

The metal oxide fine particles may be treated with a coupling agent to react a hydroxyl group existing on the surface of each of the metal oxide fine particles with the coupling agent, so that a functional group can be introduced through a chemical bond on the surface of each of the metal oxide fine particles. After a functional group is introduced on the surface of each of the metal oxide fine particles, a polymerizable monomer having a reactive group which can be reacted with the functional group is reacted with the metal oxide fine particles, and a polymer is synthesized from the polymerizable monomer on the surface of each of the metal oxide fine particles, so that the surface of each of the metal oxide fine particles can be coated with the polymer in seamless manners.

The coupling agent is not particularly limited, so long as it is a compound having a reactive site reacting with a hydroxyl group existing on the surface of each of the metal oxide fine particles and a functional group reacting with a reactive group of the polymerizable monomer having the reactive group, but examples thereof may include silane coupling agents and titanate type coupling agents having various functional groups. When a silane coupling agent is used, various functional groups are introduced through an —O—Si— bond on the surface of each of the metal oxide fine particles by reacting with a hydroxyl group existing on the surface of each of the metal oxide fine particles. Also, when a titanate type coupling agent is used, various functional groups are introduced through an —O—Ti— bond on the surface of each of the metal oxide fine particles. As the coupling agent, silane coupling agents are preferred because silane coupling agents having various functional groups are commercially available and therefore can easily be obtained. Examples of the functional group contained in the coupling agent may include a vinyl group, a (meth)acryloyl group, an epoxy group, an amino group, an isocyanate group, and a mercapto group.

The silane coupling agent is not particularly limited, so long as it is a silane coupling agent containing, for example, a vinyl group, a (meth)acryloyl group, an epoxy group, an amino group, an isocyanate group, or a mercapto group, but examples thereof may include vinyl group-containing silane coupling agents such as vinyl-trimethoxysilane, vinyldimethylmethoxysilane, vinyltrichlorosilane, and vinyldimethylchloro-silane; (meth)acryloyl group-containing silane coupling agents such as γ-(meth)acryloxypropyl-trimethoxysilane, γ-(meth)acryloxypropyltriethoxy-silane, γ-(meth)acryloxypropylmethyldimethoxy-silane, γ-(meth)acryloxypropylmethyldiethoxysilane, and N-β-(N-vinylbenzylaminoethyl)-γ-aminopropyl-trimethoxysilane; epoxy group-containing silane coupling agents such as β-(3,4-epoxycyclohexyl)-ethyltrimethoxysilane, β-(3,4-epoxycyclohexyl)-ethyltriethoxysilane, β-(3,4-epoxycyclohexyl)-ethyltriisopropoxysilane, β-(3,4-epoxycyclohexyl)-ethylmethyldimethoxysilane, β-(3,4-epoxycyclo-hexyl)ethylmethyldiethoxysilane, γ-glycidoxy-propyltrimethoxysilane, γ-glycidoxypropyl-triethoxysilane, γ-glycidoxypropyltriisopropoxy-silane, γ-glycidoxypropylmethyldimethoxysilane, and γ-glycidoxypropylmethyldiethoxysilane; amino group-containing silane coupling agents such as γ-aminop-ropyltrimethoxysilane, γ-aminopropyl-triethoxysilane, γ-aminopropylmethyldimethoxy-silane, γ-aminopropylmethyldiethoxysilane, N-(β-aminoethyl)-γ-aminopropyltrimethoxysilane, N-(β-aminoethyl)-γ-aminopropyltriethoxysilane, N-(β-aminoethyl)-γ-aminopropylmethyldimethoxysilane, N-(β-aminoethyl)-γ-aminopropylmethyldiethoxysilane, N-phenyl-γ-aminopropyltrimethoxysilane, and N-phenyl-γ-aminopropyltriethoxysilane; isocyanate group-containing silane coupling agents such as γ-isocyanopropyltrimethoxysilane, γ-isocyanopropyl-triethoxysilane; γ-isocyanopropylmethyldimethoxy-silane, and γ-isocyanopropylmethyldiethoxysilane; and mercapto group-containing silane coupling agents such as γ-mercaptopropyltrimethoxysilane. These silane coupling agents may be used alone, or two or more kinds of these silane coupling agents may also be used in combination. In these silane coupling agents, vinyl group-containing silane coupling agents and (meth)acryloyl group-containing silane coupling agents are preferred because polymer synthesis can efficiently be carried our from the surface of each of the metal oxide fine particles.

To treat the metal oxide fine particles with the coupling agent, for example, the metal oxide fine particles and the coupling agent may be mixed and stirred in an aqueous medium. At that time, to promote the reaction of the metal oxide fine particles with the coupling agent, they can preferably be warmed or heated, if necessary, to a temperature of not lower than 30° C. and not higher than 100° C., more preferably not lower than 40° C. and not higher than 80° C. The amount of coupling agent to be used may preferably be not smaller than 0.05% by mass and not greater than 20% by mass, more preferably not smaller than 0.1% by mass and not greater than 15% by mass or less, and still more preferably not smaller than 0.5% by mass and not higher than 10% by mass or less, relative to the metal oxide fine particles. When the amount of coupling agent to be used is smaller than 0.05% by mass, the surface of each of the metal oxide fine particles cannot sufficiently be coated with a polymer. In contrast, when the amount of coupling agent to be used is greater than 20% by mass, the viscosity of the reaction solution may be increased, and the reaction solution may cause gelation.

The aqueous medium to be used when the metal oxide fine particles are treated with the coupling agent is similar to the aqueous medium to be used for polymerization reaction explained below, and it may be the same as, or different from, the aqueous medium to be used for polymerization reaction.

When the metal oxide fine particles are treated with the coupling agent, the metal oxide fine particles may preferably be dispersed in the aqueous medium; therefore, a dispersion stabilizer can be used, if necessary. Examples of the dispersion stabilizer may include heretofore known surfactants and polymer dispersion stabilizers such as POVAL. These dispersion stabilizers may be used alone, or two or more kinds of these dispersion stabilizers may also be used in combination. The amount of dispersion stabilizer to be used may preferably be at least 0% by mass and not greater than 5% by mass, more preferably at least 0% by mass and not greater than 4% by mass, and still more preferably at least 0% by mass and not greater than 3% by mass or less, relative to the aqueous medium. When the amount of dispersion stabilizer to be used is greater than 5% by mass, the metal oxide fine particles cannot efficiently be treated with the coupling agent.

In the case of a coupling agent having a polymerizable reactive group, when an unreacted coupling agent exists after the metal oxide fine particles are treated with the coupling agent, it acts as a crosslinking agent at the polymerization step, and the coating polymer comes to have a crosslinking structure, thereby lowering their dispersibility in solvents, resins, and the like. Therefore, after the metal oxide fine particles are treated with the coupling agent, the metal oxide fine particles treated with the coupling agent can be washed for removing the unreacted coupling agent. For washing the metal oxide fine particles treated with the coupling agent, for example, they may be dispersed again in an appropriate solvent and subjected to centrifugal separation, and supernatant liquid is discarded and only the precipitate is collected. The operation including re-dispersion, centrifugal separation, and collection of only the precipitate is not always carried out from an economical point of view. When this operation is carried out, it may be repeated only once or more than once, but may preferably be repeated three times or more.

The polymerization reaction is carried out in an aqueous medium in the presence of the metal oxide fine particles, preferably the metal oxide fine particles treated with the coupling agent. When the polymerization reaction is carried out in the presence of the metal oxide fine particles treated with the coupling agent, the dispersion obtained by treating the metal oxide fine particles with the coupling agent may be used, as it is, for the polymerization reaction, or the dispersion obtained by dispersing the metal oxide fine particles again in an aqueous medium after treatment with the coupling agent may be used.

The polymerizable monomer to be used for the polymerization reaction may appropriately be selected from the polymerizable monomers having a reactive group which can be reacted with a functional group introduced on the surface of each of the metal oxide fine particles, depending on the functional group, and it is not particularly limited, but examples thereof may include polymerizable monomers having a reactive group which can be reacted with a functional group such as a vinyl group, a (meth)acryloyl group, an epoxy group, an amino group, an isocyanate group, or a mercapto group, for example, polymerizable monomers having a vinyl group, a (meth)acryloyl group, an epoxy group, an amino group, a carboxyl group, a hydroxyl group, or the like. These polymerizable monomers may be used alone, or two or more kinds of these polymerizable monomers may also be used in combination.

Examples of the polymerizable monomer having a vinyl group may include halogenated vinyl compounds such as vinyl chloride and vinylidene chloride; vinyl esters such as vinyl acetate; and styrene derivatives such as styrene, α-methyl-styrene, vinyl toluene, and chlorostyrene. These polymerizable monomers may be used alone, or two or more kinds of these polymerizable monomers may also be used in combination. In these polymerizable monomers, styrene derivatives such as styrene are preferred.

Examples of the polymerizable monomer having a (meth)acryloyl group may include (meth)acrylates such as methyl(meth)acrylate, ethyl(meth)-acrylate, butyl(meth)acrylate, 2-ethylhexyl(meth)acrylate, and cyclohexyl(meth)acrylate. These polymerizable monomers may be used alone, or two or more kinds of these polymerizable monomers may also be used in combination. In these polymerizable monomers, (meth)acrylates such as methyl(meth)acrylate, butyl(meth)acrylate, and cyclohexyl(meth)acrylate are preferred.

Examples of the polymerizable monomer having an amino group may include (meth)acrylates such as aminoethyl(meth)acrylate, dimethylaminoethyl(meth)acrylate, and dimethylaminopropyl(meth)-acrylate; vinyl amines such as N-vinyldiethylamine and N-acetylvinylamine; allylamine compounds such as a-methylallylamine and N,N-dimethylallylamine; (meth)acrylamide compounds such as (meth)acryl-amide, N-methyl(meth)acrylamide, and N,N-dimethyl-(meth)acrylamide; and aminostyrene compounds such as p-aminostyrene. These polymerizable monomers may be used alone, and two or more kinds of these polymerizable monomers may also be used in combination. In these polymerizable monomers, (meth)acrylates such as aminoethyl(meth)acrylate and dimethylaminoethyl(meth)acrylate are preferred.

Examples of the polymerizable monomer having an epoxy group may include unsaturated carboxylic acid esters such as glycidyl(meth)acrylate; and unsaturated glycidyl ethers such as vinyl glycidyl ether and allyl glycidyl ether. These polymerizable monomers may be used alone, or two or more kinds of these polymerizable monomers may also be used in combination. In these polymerizable monomers, unsaturated carboxylic acid esters such as glycidyl(meth)acrylate are preferred.

Examples of the polymerizable monomer having a carboxyl group may include unsaturated monocarboxylic acids such as (meth)acrylic acid and crotonic acid; unsaturated dicarboxylic acids such as maleic acid, itaconic acid, and citraconic acid; monoester compounds of these unsaturated dicarboxylic acids; and anhydrides of these unsaturated dicarboxylic acids. These polymerizable monomers may be used alone, or two or more kinds of these polymerizable monomers may also be used in combination. In these polymerizable monomers, unsaturated monocarboxylic acids such as (meth)acrylic acid are preferred.

Examples of the polymerizable monomer having a hydroxyl group may include (meth)acrylates such as 2-hydroxyethyl(meth)acrylate, 2-hydroxypropyl(meth)acrylate, methyl α-hydroxymethylacrylate, and ethyl α-hydroxymethlacrylate; polycaprolactone-modified (meth)acrylates; and polyoxy-ethylene-modified and polyoxypropylene-modified (meth)acrylates. These polymerizable monomers may be used alone, or two or more kinds of these polymerizable monomers may also be used in combination. In these polymerizable monomers, (meth)acrylates such as 2-hydroxyethyl (meth)acrylate and 2-hydroxypropyl(meth)acrylate are preferred.

The amount of polymerizable monomer to be used may appropriately be selected depending on the amount of metal oxide fine particles to be used, and it is not particularly limited, but may preferably be not smaller than 1 part by mass and not greater than 200 parts by mass, more preferably not smaller than 2 parts by mass and not greater than 100 parts by mass, and still more preferably not smaller than 5 parts by mass and not greater than 50 parts by mass, relative to 100 parts by mass of the metal oxide fine particles. When the amount of polymerizable monomer to be used is smaller than 1 part by mass, polymerization reaction cannot proceed smoothly and the surface of each of the metal oxide fine particles cannot efficiently be coated with a polymer. In contrast, when the amount of polymerizable monomer to be used is greater than 200 parts by mass, many polymer particles not containing the metal oxide fine particles may be prepared.

The polymerization initiator is not particularly limited, so long as it is a water-soluble radical polymerization initiator, but may include peroxides such as hydrogen peroxide, potassium persulfate, potassium persulfate, sodium persulfate, ammonium persulfate, and potassium perphosphorate; redox initiators in which these peroxides are combined with reducing agents such as ascorbic acid and its salt, erythorbic acid and its salt, tartaric acid and its salt, citric acid and its salt, sodium thiosulfate, sodium hydrogensulfite, sodium pyrrosulfite, Rongalit C (NaHSO₂.CH₂O.H₂O), Rongalit Z (ZnSO₂.CH₂O.H₂O), and Dechroline (Zn(HSO₂.CH₂O)₂); hydroperoxides such as t-butyl hydroperoxide, t-amyl hydroperoxide, t-hexyl hydroperoxide, p-menthane hydroperoxide, and cumene hydroperoxide; dialkyl peroxides such as di-t-butyl peroxide and di-t-amyl peroxide; diacyl peroxide such as dibenzoyl peroxide, dioctanoyl peroxide, didecanoyl peroxide, and didodecanoyl peroxide; peroxy esters such as t-butylperoxy pivalate, t-amylperoxy pivalate, and t-butylperoxy benzoate; and azo compounds such as 2,2′-azobis-(isobutyronitrile), 2,2′-azobis(2-methylbutyro-nitrile), 2,2′-azobis(2,4-dimethylvaleronitrile), 2,2′-azobis(4-methoxy-2,4-dimethylvaleronitrile), dimethyl 2,2′-azobis(isobutyrate), 4,4′-azobis(4-cyanovaleric acid), 2,2′-azobis(2-methylpropion-diamine) dihydrochloride, 2,2′-azobis[N-(2-carboxyethyl)-2-methylpropiondiamine]n-hydrate, 2,2′-azobis{2-methyl-N-[2-(1-hydroxybutyl)]-propionamide}, 2,2′-azobis{2-methyl-N-[1,1-bis(hydroxymethyl-2-hydroxyethyl)propionamide], 2,2′-azobis(1-imino-1-pyrrolidino-2-ethylpropane)dihydrochloride, 2,2′-azobis[2-(2-imidazolin-2-yl)propane], 2,2′-azobis[2-(2-imidazolin-2-yl)-propane]dihydrochloride, 2,2′-azobis[2-(2-imidazolin-2-yl)propane]disulfate dihydrate, 2,2′-azobis{2-[1-(2-hydroxyethyl)-2-imidazolin-2-yl]propane}dihydrochloride, and 2,2′-azobis[2-(5-methyl-2-imidazolin-2-yl)propane]dihydrochloride, 1,1′-azobis(cyclohexane-1-carbonitrile). These polymerization initiators may be used alone, or two or more kinds of these polymerization initiators may also be used in combination.

The amount of polymerization initiator to be used may appropriately be adjusted depending on the amount of polymerizable monomer to be used, and it is not particularly limited, but may preferably be not smaller than 0.001% by mass and not greater than 3% by mass, more preferably not smaller than 0.005% by mass and not greater than 2% by mass, and still more preferably not smaller than 0.01% by mass and not greater than 1% by mass, relative to the polymerizable monomer.

The polymerization reaction of the monomer components is carried out in the aqueous medium. The term “aqueous medium” as used herein means water or a mixed solvent of water and a water-miscible organic solvent. When a mixed solvent of water and a water-miscible organic solvent is used as the aqueous medium, the monodisperse state of the metal oxide fine particles as a raw material and the polymer-coated metal oxide fine particles prepared can be kept sufficiently well without using a dispersion stabilizer such as a surfactant. However, when it is not desirable that an organic solvent is contaminated in the aqueous dispersion of polymer-coated metal oxide fine particles or in the coating composition, the monodisperse state of the metal oxide fine particles as a raw material and the polymer-coated metal oxide fine particles prepared can be kept sufficiently well by using a dispersion stabilizer.

When a mixed solvent of water and a water-miscible organic solvent is used as the aqueous medium, a ratio of a water-miscible organic solvent to water may preferably be at least 0% by mass and not greater than 40% by mass, more preferably at least 0% by mass and not greater than 20% by mass.

Examples of the water-miscible organic solvent which can be used in combination with water may include alcohols such as methanol, ethanol, isopropyl alcohol, n-propyl alcohol, and allyl alcohol; glycols such as ethylene glycol, propylene glycol, butylene glycol, hexylene glycol, pentanediol, hexanediol, heptanediol, and dipropylene glycol; ketones such as acetone, methyl ethyl ketone, and methyl propyl ketone; esters such as methyl formate, ethyl formate, methyl acetate, and methyl acetoacetate; and ethers such as diethylene glycol monomethyl ether, diethylene glycol monoethyl ether, diethylene glycol dimethyl ether, ethylene glycol monomethyl ether, ethylene glycol monoethyl ether, and dipropylene glycol monomethyl ether. These organic solvents may be used alone, or two or more kinds of these organic solvents may also be used in combination. In these organic solvents, preferred are organic solvents which become poor solvents for a polymer synthesized from monomer components, that is, which dissolve the monomer components but do not dissolve a polymer synthesized from the monomer components.

The reaction temperature at which the polymerization reaction is carried out is not particularly limited, but may preferably be not lower than 40° C. and not higher than 90° C., more preferably not lower than 50° C. and not higher than 80° C. Also, the reaction time may appropriately be adjusted depending on the amounts of metal oxide fine particles and polymerizable monomer to be used, and it is not particularly limited, but may preferably be not shorter than 1 hour and not longer than 24 hours, more preferably not shorter than 3 hours and not longer than 12 hours.

After the polymerization reaction, an aqueous dispersion of polymer-coated metal oxide fine particles is obtained, in which the surface of each of the metal oxide fine particles is coated with a polymer. The aqueous dispersion obtained may be used, as it is, or for example, the polymerization reaction solution is subjected to centrifugal separation to separate supernatant liquid and precipitate, which precipitate is collected and dried to give the polymer-coated metal oxide fine particles, and they may be used as powder. The method of drying the polymer-coated metal oxide fine particles may appropriately be selected from the heretofore known drying methods, and it is not particularly limited, but examples thereof may include natural drying, heating drying, reduced-pressure drying, and spray drying. The polymer-coated metal oxide fine particles obtained may be used as powder itself or may be used as a dispersion in which the polymer-coated metal oxide fine particles are dispersed again in an appropriate solvent.

The method of dispersing the polymer-coated metal oxide fine particles again in a dispersion medium may appropriately be selected from the heretofore known drying methods, and it is not particularly limited, but examples thereof may include methods using a stirrer, a ball mill, a sand mill, or an ultrasonic homogenizer.

Also, when the polymer-coated metal oxide fine particles are in the form of a dispersion and the polymer-coated metal oxide fine particles are dispersed in a different dispersion medium, there can be used a method in which the polymer-coated metal oxide fine particles are separated, for example, by filtration, centrifugal separation, or evaporation of the dispersion medium, and then mixed with a dispersion medium to be replaced, followed by dispersing the mixture using any of the methods described above, or what is called a solvent replacement method with heating, in which the dispersion is heated so that part or all of the dispersion medium constituting the dispersion is evaporated and distilled out, while a dispersion medium to be replaced is mixed therein.

<<Aqueous Dispersion of Polymer-Coated Metal Oxide Fine Particles>>

The aqueous dispersion of polymer-coated metal oxide fine particles of the present invention (hereinafter referred to simply as the “aqueous dispersion”) comprises the polymer-coated metal oxide fine particles, the polymer being formed by emulsion polymerization using a polymerizable monomer and a radical initiator.

In the aqueous dispersion of the present invention, a ratio of a total amount of residual monomer to a total amount of polymer coating may preferably be not greater than 0.5% by mass, more preferably not greater than 0.4% by mass, and still more preferably not greater than 0.3% by mass. A ratio of a total amount of residual monomer to a total amount of polymer coating is calculated by the following formula:
[Total amount (g) of residual monomer/Total amount (g) of polymer coating]×100.

The total amount (g) of polymer coating is calculated by the following formula:
Recovered amount (g) of aqueous dispersion×Nonvolatile content (% by mass) of aqueous dispersion×Thermal mass loss (% by mass) of polymer-coated metal oxide fine particles.

The total amount (g) of residual monomer is calculated by the following formula:
Residual monomer amount (ppm) in system×10⁻⁶×Recovered amount (g) of aqueous dispersion.

The nonvolatile content of aqueous dispersion is expressed, in the unit of % by mass, as a ratio of mass of a residual potion after drying to mass before drying, which residual portion is obtained by weighing about 1 g of the aqueous dispersion and drying it with a hot air drying machine at 105° C. for 1 hour. The thermal mass loss of polymer-coated metal oxide fine particles is a mass loss as measured under the condition of a temperature rise of from 100° C. to 500° C. The residual monomer amount in the system is a value as measured by gas chromatography.

In the aqueous dispersion of the present invention, a ratio of a total amount of residual monomer to a total amount of polymer coating may preferably be not greater than 0.5% by mass, and therefore, for example, when the aqueous dispersion is used for coating compositions, the water resistance and weather resistance of coating films are remarkably improved, and when the aqueous dispersion is used for resin composition, resin formed articles having excellent water resistance and weather resistance can be provided.

In the aqueous dispersion of the present invention, the kind and shape, number-average particle diameter and coupling agent treatment of metal oxide fine particles; the kind and bonding state of a coating polymer; and the number-average particle diameter of polymer-coated metal oxide fine particles, and the like are similar to the case of the above-described polymer-coated metal oxide fine particles. The metal oxide fine particles may preferably comprise zinc oxide type fine particles, titanium oxide fine particles, silica-coated zinc oxide fine particles, or silica-coated titanium oxide fine particles. Also, the metal oxide fine particles may preferably be treated with a coupling agent in advance of emulsion polymerization.

The content of polymer-coated metal oxide fine particles in the aqueous dispersion of the present invention may preferably be not smaller than 1% by mass and not greater than 80% by mass, more preferably not smaller than 5% by mass and not greater than 70% by mass, and still more preferably not smaller than 10% by mass and not greater than 60% by mass, relative to the total mass of the aqueous dispersion. When the content of polymer-coated metal oxide fine particles is smaller than 1% by mass, a dispersion medium may be used more than necessary and production cost may be increased. In contrast, when the content of polymer-coated metal oxide fine particles is greater than 80% by mass, the polymer-coated metal oxide fine particles may cause aggregation to form a high-order structure; therefore, dispersibility may be lowered.

The aqueous dispersion of the present invention can contain, depending on the intended use, at least one additive, such as thermal stabilizers, antioxidants, light stabilizers, plasticizers, and dispersants, at their ordinary addition amounts.

The aqueous dispersion of polymer-coated zinc oxide type fine particles of the present invention can be used, for example, as a material for coating compositions and resin compositions.

<<Process for Producing Aqueous Dispersion of Polymer-Coated Metal Oxide Fine Particles>>

A process for producing an aqueous dispersion of polymer-coated metal oxide fine particles according to the present invention (hereinafter referred to simply as the “production process of the present invention”) is a process in which the emulsion polymerization of a polymerizable monomer is carried out in the presence of metal oxide fine particles, preferably metal oxide fine particles treated with a coupling agent, in an aqueous medium, and it is substantially the same as the above-described process for producing polymer-coated metal oxide fine particles, except that it is characterized in the method of using a radical initiator described later.

In the production process of the present invention, when emulsion polymerization using a polymerizable monomer and a radical initiator is carried out, two or more radical initiators having different half-life periods are used as the radical initiator, and/or, after the portion of the radical initiator is added to the reaction system, the residue of the radical initiator is added after an interval of time. This makes it possible to increase the degree of polymerization at the initial stage, to keep the degree of polymerization highly at the final stage, and to allow the polymerizable monomer to be efficiently polymerized on the surface of each of the metal oxide fine particles; therefore, a ratio of a total amount of residual monomer to a total amount of polymer coating can preferably be reduced to not greater than 0.5% by mass in the aqueous dispersion of polymer-coated metal oxide fine particles finally obtained. When a ratio of a total amount of residual monomer to a total amount of polymer coating is greater than 0.5% by mass after the polymerization reaction, the aqueous dispersion of polymer-coated metal oxide fine particles in which a ratio of a total amount of residual monomer to a total amount of polymer coating may preferably be not greater than 0.5% by mass can be obtained by carrying out the reduced-pressure treatment of the reaction solution to remove the residual monomer.

The radical initiator is not particularly limited, so long as it is a water-soluble radical initiator, but examples thereof may include peroxides such as potassium persulfate (half-life period (80° C.): 3.59 hr), sodium persulfate (half-life period (80° C.): 3.59 hr), and ammonium persulfate (half-life period (80° C.) : 1.26 hr); and azo compounds such as 2,2′-azobis(2-methylpropion-diamine) dihydrochloride (half-life period (80° C.): 0.48 hr; V-50, available from Wako Pure Chemical Industry Ltd.), 2,2′-azobis[N-(2-carboxyethyl)-2-methylpropiondiamine]tetrahydrate (half-life period (80° C.) : 0.51 hr; VA-057, available from Wako Pure Chemical Industry Ltd.), 2,2′-azobis(1-imino-1-pyrrolidino-2-ethylpropane)dihydrochloride (half-life period (80° C.): 2.10 hr; VA-067, available from Wako Pure Chemical Industry Ltd.), and 2,2′-azobis{2-methyl-N-[2-(1-hydroxybutyl)]-propionamide} (half-life period (80° C.): 9.17 hr; VA-085, available from Wako Pure Chemical Industry Ltd.).

These radical initiators may be used, for example, by combining a radical initiator having a long half-life period with a radical initiator having a short half-life period, or by first adding a portion of the radical initiator to the reaction system and then adding the residue of the radical initiator at an interval of time. In the latter case, the timing of adding the residue of the radical initiator may appropriately be adjusted depending on the half-life period of the radical initiator first added, and it is not particularly limited, but for example, it may be added once or twice or more separately after an interval of time, which may preferably be equivalent to from ⅙ to ⅚, more preferably from ¼ to ¾, and still more preferably from ⅓ to ⅔, for the half-life period of the radical initiator first added.

<<Applications of Polymer-Coated Metal Oxide Fine Particles>>

The polymer-coated metal oxide fine particles of the present invention can be used, for example, for coating compositions comprising the polymer-coated metal oxide fine particles and a binder component capable of forming a coating film in which the polymer-coated metal oxide fine particles are dispersed; resin compositions comprising the polymer-coated metal oxide fine particles and a resin component capable of forming a continuous phase in which the polymer-coated metal oxide fine particles are dispersed; and resin formed articles obtained by forming the resin compositions in one shape selected from a plate, a sheet, a film, and a fiber.

<Coating Composition>

The paint composition of the present invention comprises polymer-coated metal oxide fine particles and a binder component capable of forming coating film in which the polymer-coated metal oxide fine particles are dispersed. The polymer-coated metal oxide fine particles may be in the form of an aqueous dispersion.

The binder component may appropriately be selected depending on the intended use of coating compositions, the kinds of substrates, and the required properties such as heat resistance, abrasion resistance, and wear resistance, and it is not particularly limited, but examples thereof may include organic binders, e.g., thermoplastic resins or thermosetting resins such as (meth)-acrylic type resins, styrene type resins, vinyl chloride type resins, vinylidene chloride type resins, silicone type resins, melamine type resins, urethane type resins, alkyd type resins, phenol type resins, epoxy type resins, and unsaturated polyester type resins; ultraviolet curable resins such as ultraviolet curable acrylic resins and ultraviolet curable acrylic-silicone resins; synthetic rubbers or natural rubbers such as ethylene-propylene copolymer rubbers, polybutadiene rubbers, styrene-butadiene rubbers, and acrylonitrile-butadiene rubbers; and inorganic binders, e.g., silica sol, alkali silicates, silicon alkoxides and hydrolysis condensation product thereof, and phosphates. These binders may be used alone, and two or more kinds of these binders may also be used in combination.

The contents of polymer-coated metal oxide fine particles and binder component in the coating composition of the present invention may preferably be not smaller than 1% by mass and not greater than 99% by mass, more preferably not smaller than 3% by mass and not greater than 90% by mass, and still more preferably not smaller than 5% by mass and not greater than 80% by mass, relative to a total mass of solid content in the coating composition, for the polymer-coated metal oxide fine particles, and may preferably be not smaller than 1% by mass and not greater than 99.9% by mass, more preferably not smaller than 10% by mass and not greater than 99% by mass, and still more preferably not smaller than 20% by mass and not greater than 95% by mass, relative to a total mass of solid content in the coating composition, for the binder component. When the content of polymer-coated metal oxide fine particles is smaller than 1% by mass, the effect of adding the polymer-coated zinc oxide fine particles cannot be obtained. In contrast, when the content of polymer-coated metal oxide fine particles is greater than 99% by mass, the adhesion of coating films to substrates to which the coating composition is to be applied may be deteriorated, and the abrasion resistance and wear resistance of coating films may be lowered. A total amount of polymer-coated zinc oxide fine particles and binder component in the coating composition of the present invention may preferably be not smaller than 1% by mass and not greater than 80% by mass, more preferably not smaller than 5% by mass and not greater than 70% by mass, and still more preferably not smaller than 10% by mass and not greater than 60% by mass, relative to the total mass of the coating composition, and it may appropriately be selected depending on the intended use, workability, and the like. The residue of the coating composition is a solvent for dispersing the polymer-coated metal oxide fine particles and dissolving or dispersing the binder component, and at least one additive used depending on the intended use, such as pigments, plasticizers, drying accelerators, dispersants, and defoaming agents.

In the coating composition of the present invention, the binder component may be dissolved or dispersed in a solvent. The solvent dissolving or dispersing the binder component may appropriately be selected depending on the intended use of the coating composition, the kind of the binder component, and the like, and it is not particularly limited, but examples thereof may include organic solvents such as alcohols, aliphatic carboxylic acid esters, aromatic carboxylic acid esters, ketones, ethers, ether esters, aliphatic hydrocarbons, aromatic hydrocarbons, and halogenated hydrocarbons; water; mineral oils, vegetable oils, wax oils, and silicone oils. These solvents may be used alone, and two or more kinds of these solvents may also be used in combination.

The method for producing the coating composition of the present invention is not particularly limited, but examples thereof may include a method in which polymer-coated metal oxide fine particles or an aqueous dispersion thereof is added to a solvent containing a binder component, followed by mixing; a method in which a dispersion containing polymer-coated metal oxide fine particles dispersed in a solvent is mixed with a solvent containing a binder component; a method in which a binder component is added to a dispersion containing polymer-coated metal oxide fine particles dispersed in a solvent, followed by mixing; a method in which a solvent containing a binder component is added to an aqueous dispersion of polymer-coated metal oxide fine particles, followed by mixing; and a method in which a binder component is added, together with a solvent, to an aqueous dispersion of polymer-coated metal oxide fine particles, followed by mixing. The method of dispersion may appropriately be selected from the heretofore known methods of dispersion, and it is not particularly limited, but examples thereof may include methods using a stirrer, a ball mill, a sand mill, an ultrasonic homogenizer, and the like.

The coating composition of the present invention is applied to a substrate and dried to form a coating film containing polymer-coated metal oxide fine particles on the surface of the substrate. Depending on the kind of binder component to be added, the coating film may be heated at a temperature lower than the deformation temperature of the substrate to harden the coating film. The method of applying the coating composition of the present invention may appropriately be selected from the heretofore known methods of application, and it is not particularly limited, but examples thereof may include a brush coating method, a roll coater method, and a spray method. The method of drying the coating film may appropriately be selected from the heretofore known methods of drying, and it is not particularly limited, but examples thereof may include natural drying, warm wind drying, and infrared irradiation. The method of heating the coating film may appropriately be selected from the heretofore known methods of heating, and it is not particularly limited, but examples thereof may include warm wind heating and infrared irradiation.

Using the coating composition of the present invention, there can be obtained coating films which become hardened to have high durability because their containing polymer-coated metal oxide fine particles, which have excellent low staining properties to be hardly stained, and which have excellent water resistance and weather resistance to enable resistance to rain water in the open air.

<Resin Composition and Resin Formed Article>

The resin composition of the present invention comprising polymer-coated metal oxide fine particles and a resin component capable of forming a continuous phase in which the polymer-coated metal oxide fine particles are dispersed. The polymer-coated metal oxide fine particles may be in the form of an aqueous dispersion.

The resin component may appropriately be selected depending on the intended use of the resin composition, and it is not particularly limited, but examples thereof may include thermoplastic resins or thermosetting resins, such as olefin type resins, e.g., polyethylene, polypropylene; styrene type resins; vinyl chloride resin; vinylidene chloride type resins; polyvinyl alcohol; polyester type resins, e.g., polyethylene terephthalate, polyethylene naphthalate; polyamide type resins; polyimide type resins; (meth)acrylic type resins, e.g., poly(methyl methacrylate); phenol type resins; urea type resins; melamine type resins; unsaturated polyester type resins; polycarbonate type resins; and epoxy resins; and synthetic rubbers or natural rubbers, such as ethylene-propylene copolymer rubbers, polybutadiene rubbers, styrene-butadiene rubbers, and acrylonitrile-butadiene rubbers. These resin components may be used alone, or two or more kinds of these resin components may also be used in combination.

The contents of polymer-coated metal oxide fine particles and resin component in the resin composition of the present invention may preferably be not smaller than 1% by mass and not greater than 99% by mass, more preferably not smaller than 3% by mass and not greater than 80% by mass, and still more preferably not smaller than 3% by mass and not greater than 50% by mass, relative to a total mass of solid content in the resin composition, for the polymer-coated metal oxide fine particles, and may preferably be not smaller than 1% by mass and not greater than 99.9% by mass, more preferably not smaller than 20% by mass and not greater than 99.5% by mass, and still more preferably not smaller than 50% by mass and not greater than 99% by mass, relative to a total mass of solid content in the resin composition, for the resin component. When the content of polymer-coated metal oxide fine particles is smaller than 1% by mass, the effect of adding the polymer-coated zinc oxide fine particles cannot be obtained. In contrast, when the content of polymer-coated metal oxide fine particles is greater than 99% by mass, the mechanical strength of resin formed articles obtained from the resin composition may be lowered.

When the resin composition of the present invention is required to improve processability at the time of forming processing and to provide flexibility, a plasticizer can be added. The amount of plasticizer to be added may appropriately be selected depending on the kind of resin component, processing conditions, intended use, and the like, and it is not particularly limited, but may preferably be not smaller than 1% by mass and not greater than 20% by mass, more preferably not smaller than 2% by mass and not greater than 15% by mass, relative to the total mass of the resin composition. When the amount of plasticizer to be added is smaller than 1% by mass, the effect of adding the plasticizer cannot be obtained. In contrast, when the amount of plasticizer to be added is greater than 20% by mass, resin formed articles obtained from the resin composition cannot have stable physical properties.

Further, the resin composition of the present invention can contain, depending on the intended use, at least one additive, such as thermal stabilizers, antioxidants, light stabilizers, fungicides, dyes, pigments, antistatic agents, and ultraviolet absorbents, at their ordinary addition amounts.

The method for producing the resin composition of the present invention is not particularly limited, but examples thereof may include a method in which when a resin component in the form of pellets or powder is melt kneaded, polymer-coated metal oxide fine particles or an aqueous dispersion thereof is added thereto, followed by mixing; a method in which polymer-coated metal oxide fine particles or an aqueous dispersion thereof is mixed with a solution containing a resin component dissolved therein, followed by removing a solvent; and a method in which the polymer-coated metal oxide fine particles or an aqueous dispersion thereof is mixed at the step of producing a resin component.

Using any of the above-described methods, a resin composition containing polymer-coated metal oxide fine particles dispersed in a resin component is obtained. The resin composition may be in any form, selected from the forms of ordinary forming materials, such as powder and pellets. The resin composition obtained is formed into a plate, a sheet, a film, a fiber, and the like, thereby obtaining resin formed articles containing the polymer-coated metal oxide fine particles, which effectively block ultraviolet rays and infrared rays without damaging the transparency and hue of their base resins, and which have antistatic properties and water resistance.

The resin formed article of the present invention is obtained by forming the resin composition in one shape selected from a plate, a sheet, a film, and a fiber.

The method for producing the resin formed article of the present invention may appropriately be selected from the heretofore known methods of forming, and it is not particularly limited, but will be explained with specific examples.

When a thermoplastic resin plate containing the polymer-coated metal oxide fine particles of the present invention dispersed therein is produced, for example, pellets or powder of a thermoplastic resin is melt kneaded with a specific amount of powder of the polymer-coated metal oxide resin fine particles to form a resin composition containing the polymer-coated metal oxide fine particles uniformly mixed in the thermoplastic resin, and the resin composition is then formed, continuously as it is, or after once converted into pellets, using a method in which the resin composition is processed by injection molding, extrusion molding, or compression molding into a flat or curved thermoplastic resin plate. The flat thermoplastic resin plate can further be formed into any shape, for example, in the shape of a corrugated plate, by post-processing.

Also, when a thermoplastic resin sheet, film, or fiber containing the polymer-coated metal oxide fine particles of the present invention dispersed therein is produced, for example, pellets or powder of a thermoplastic resin is melt kneaded with a specific amount of powder of the polymer-coated metal oxide fine particles to form a resin composition containing the polymer-coated metal oxide fine particles uniformly mixed in the thermoplastic resin, and the resin composition is then formed, continuously as it is, or after once converted into pellets, using any of the heretofore known methods for producing a sheet or a (drawn) film, in which the resin composition is formed in the shape of a sheet or a film by extrusion molding, and then, if necessary, drawn in the uniaxial or biaxial direction, or any of the heretofore known methods of fiber formation, such as melt spinning. Also, when a sheet or a film which serves as a substrate is formed by extrusion molding, co-extrusion can also be carried out using powder of the polymer-coated metal oxide fine particles of the present invention and pellets or powder of a thermoplastic resin as raw materials, or using pellets or powder of a thermoplastic resin containing the polymer-coated metal oxide fine particles of the present invention dispersed in advance therein as a raw material, to give a laminated sheet or a laminated film.

Further, in particular, when a sheet, a film, or a fiber of a polyester type resin containing the polymer-coated metal oxide fine particles of the present invention dispersed therein is produced, the following alternative method, which is heretofore known, can also be used. That is, at any step in the process for producing a polyester type resin, for example, at any step in a series of steps extending from ester exchange reaction to polymerization reaction, a dispersion containing the polymer-coated metal oxide fine particles dispersed, for example, at a ratio of not lower than 0.1% by mass and not higher than 50% by mass, in a dicarboxylic acid or a glycol is added under mixing, and the polymerization reaction of a polyester type resin is completed to give a polyester type resin containing the polymer-coated metal oxide fine particles dispersed therein, after which there may be used, for example, any of the heretofore known methods for producing a sheet or a (drawn) film, in which the polyester type resin is formed in the shape of a sheet or a film by extrusion molding, and then, if necessary, drawn in the uniaxial or biaxial direction, or any of the heretofore known methods of fiber formation, such as melt spinning.

### EXAMPLES

The present invention will be explained below in detail by reference to Examples, but the present invention is not limited to these Examples. The present invention can be put into practice after appropriate modifications or variations within a range meeting the gists described above and later, all of which are included in the technical scope of the present invention.

<<Various Determination and Measurement Methods>>

With respect to metal oxide fine particles or dispersions of polymer-coated metal oxide fine particles obtained in the following Examples, the shapes and number-average particle diameters of fine particles contained and the nonvolatile contents of the dispersions were determined or measured by the methods described below. When powderization was required before determination and measurement, powderization was carried out according to the method described below and then, if not otherwise specified, powder obtained was used as a measurement sample.

<Shape>

The shape of fine particles was determined by observing the fine particles with a scanning electron microscope or a transmission electron microscope (magnification: 10,000-fold).

<Number-Average Particle Diameter>

Primary particle diameters of arbitrary one hundred fine particles contained in a photographed image which was obtained by observing the fine particles with a scanning electron microscope or a transmission electron microscope (magnification: 10,000-fold) were measured, and the number-average particle diameter was calculated by the following numerical formula. Further, when the fine particles were observed with the scanning electron microscope, the deposition treatment with a noble metal alloy was carried out to the fine particles in advance for observation; therefore, the number-average particle diameter was determined with a correction on the thickness of a deposition layer.

$${d}_{n} = ( {\sum }_{i = 1}^{n} {D}_{i} / n )$$

wherein dₙ represents the number-average particle diameter, Dᵢ represents the particle diameter of the i-th fine particle, and n represents the number of the fine particles.

<Nonvolatile Content of Dispersion>

About 1 g of a dispersion of polymer-coated metal oxide fine particles was weighed and dried using a hot air drier at 105° C. for 1 hour, and a value (unit: % by mass) obtained by representing a ratio of the mass after drying to the mass before drying by percentage was regarded as nonvolatile content.

<<Polymer-Coated Zinc Oxide Type Fine Particles and Their Applications>>

First, Production Examples 1 to 3 of zinc oxide type fine particles are shown below.

### Production Example 1

In a 10-L reactor made of glass equipped with a stirrer, a dropping inlet, a thermometer, and a reflux condenser, 0.3 kg of zinc oxide powder was added to and mixed with a mixed solvent of 1.6 kg of acetic acid and 1.6 kg of ion-exchanged water, and the mixture was heated to 100° C. with stirring, to give a zinc-containing solution (Al) as a uniform solution.

Then, 12 kg of 2-butoxyethanol was charged into a 20-L reactor made of glass equipped with a stirrer, a dropping inlet, a thermometer, and a distillate gas outlet, capable of being externally heated by heating a medium, and was heated to 153° C. and kept at the same temperature. The total amount of zinc-containing solution (Al) kept at 100° C. was added dropwise to the reactor with a metering pump over 30 minutes. The temperature of the content in the reactor changed from 153° C. to 131° C. After completion of the dropwise addition, 400 g of a 2-butoxyethanol solution in which 36.9 g of lauric acid was dissolved was added over 1 minute at the time of heating to 168° C. and kept at the same temperature for 5 hours to give 7.89 kg of a blue gray dispersion (Z-1). The dispersion (Z-1) was a dispersion in which granule-shaped fine particles having a number-average particle diameter of 20 nm were dispersed at a concentration of 3.7% by mass.

The fine particles contained in the dispersion (Z-1) was separated from the dispersion medium by centrifugal separation operation, and the fine particles obtained were washed with isopropyl alcohol and then vacuum dried (under a pressure of 1.33×10³ Pa) at 50° C. for 24 hours, to give zinc oxide type fine particles (DZ-1). The zinc oxide type fine particles (DZ-1) obtained had a number-average particle diameter of 20 nm.

### Production Example 2

In a 10-L reactor made of glass equipped with a stirrer, a dropping inlet, a thermometer, and a reflux condenser, 0.3 kg of zinc oxide powder and 36.3 g of indium acetate dihydrate was added to and mixed with a mixed solvent of 1.6 kg of acetic acid and 1.6 kg of ion-exchanged water, the mixture was heated to 100° C. with stirring, to give a zinc-containing solution (A2) as a uniform solution.

Then, 14 kg of 2-butoxyethanol was charged into a 20-L reactor made of glass equipped with a stirrer, a dropping inlet, a thermometer, and a distillate gas outlet, capable of being externally heated by heating a medium, and the mixture was heated to 153° C. and kept at the same temperature. The total amount of zinc-containing solution (A2) kept at 100° C. was added dropwise to the reactor with a metering pump over 30 minutes. The temperature of the content in the reactor changed from 153° C. to 131° C. After completion of the dropwise addition, 400 g of a 2-butoxyethanol solution in which 36.9 g of lauric acid was dissolved was added over 1 minute at the time of heating to 168° C. and kept at the same temperature for 5 hours to give 8.12 kg of a blue gray dispersion (Z-2). The dispersion (Z-2) was a dispersion in which flake-shaped fine particles having a number-average particle diameter of 18 nm were dispersed at a concentration of 3.5% by mass. With respect to the composition of the fine particles contained in the dispersion (Z-2), the content of metal oxide was 94.5% by mass and indium was at an atomic number ratio of 3.0%, relative to a total amount of metal atoms.

The fine particles contained in the dispersion (Z-2) was separated from the dispersion medium by centrifugal separation operation, and the fine particles obtained were washed with isopropyl alcohol and then vacuum dried (under a pressure of 1.33×10³ Pa) at 50° C. for 24 hours, to give zinc oxide type fine particles (DZ-2). The zinc oxide type fine particles (DZ-2) obtained had a number-average particle diameter of 18 nm.

### Production Example 3

In a 10-L reactor made of glass equipped with a stirrer, a dropping inlet, a thermometer, and a reflux condenser, 0.809 kg of zinc oxide dihydrate was added to and mixed with a mixed solvent of 2.2 kg of acetic acid and 2.2 kg of ion-exchanged water, the mixture was heated to 100° C. with stirring, to give a zinc-containing solution (A3).

Then, 8 kg of 2-butoxyethanol and 5 kg of acetic acid ethylene glycol n-butyl ether were charged into a 20-L reactor made of glass equipped with a stirrer, a dropping inlet, a thermometer, and a distillate gas outlet, capable of being externally heated by heating a medium, and the mixture was heated to 162° C. and kept at the same temperature. The total amount of zinc-containing solution (A3) kept at 100° C. was added dropwise to the reactor with a metering pump over 30 minutes. The temperature of the content in the reactor changed from 162° C. to 168° C. After completion of the dropwise addition, a solution in which 90.8 g of aluminum tris(sec-butoxide) was uniformly dissolved in 400 g of a 2-butoxyethanol solution was added at one time at the time of heating to 168° C. and kept at a temperature of 175° C. for 5 hours to give 11.5 kg of a blue gray dispersion (Z-3). The dispersion (Z-3) was a dispersion in which flake-shaped fine particles having a number-average particle diameter of 25 nm were dispersed at a concentration of 5.5% by mass. With respect to the composition of the fine particles contained in the dispersion (Z-3), the content of metal oxide was 92% by mass and aluminum was at an atomic number ratio of 9.2%, relative to a total amount of metal atoms.

The fine particles contained in the dispersion (Z-3) was separated from the dispersion medium by centrifugal separation operation, and the fine particles obtained were washed with isopropyl alcohol and then vacuum dried (under a pressure of 1.33×10³ Pa) at 50° C. for 24 hours, to give zinc oxide type fine particles (DZ-3). The zinc oxide type fine particles (DZ-3) obtained had a number-average particle diameter of 25 nm.

Then, Examples 1 to 6 and Comparative Examples 1 and 2 for the production of the polymer-coated zinc oxide type fine particles are shown below.

### Example 1

To a 2-L reactor made of glass equipped with a stirrer, a dropping inlet, a nitrogen gas introducing tube, a thermometer, and a reflux condenser, 200 g of the zinc oxide type fine particles (DZ-1), 800 g of deionized water, and 2 g of an anionic surfactant (HITENOL N-08 (polyoxyethylene alkyl ether sulfate), available from Dai-ichi Kogyo Seiyaku. Co., Ltd.) were added under a nitrogen gas blow, followed by mixing, and the mixture was heated to 50° C. with stirring. Then, 10 g of a silane coupling agent (KBM-503 (γ-meth-acryloxypropyltrimethoxysilane), available from Shin-Etsu Chemical Co., Ltd.) was added dropwise to the reactor with stirring over 30 minutes, and after completion of the dropwise addition, the mixture was kept at 50° C. for 5 hours.

Then, the mixture was heated to 75° C., and 20 g of methyl methacrylate and 4 g of a 5% aqueous solution of potassium persulfate were added thereto. The mixture was kept with stirring for 5 hours to give a dispersion (PC-1) of polymer-coated zinc oxide type fine particles.

The dispersion (PC-1) of the polymer-coated zinc oxide type fine particles obtained had a nonvolatile content of 21.8%. When the dispersion (PC-1) of the polymer-coated zinc oxide type fine particles was observed with a scanning electron microscope, it was confirmed that the surface of each of the zinc oxide type fine particles was coated with poly(methyl methacrylate) formed by polymerization in seamless manners.

The fine particles contained in the dispersion (PC-1) of the polymer-coated zinc oxide type fine particles were separated from the dispersion medium by centrifugal separation operation, and the fine particles obtained were washed with isopropyl alcohol and then vacuum dried (under a pressure of 1.33×10³ Pa) at 50° C. for 24 hours to give polymer-coated zinc oxide type fine particles (PCP-1). The number-average particle diameter of the polymer-coated zinc oxide type fine particles (PCP-1) obtained was 25 nm.

### Example 2

A dispersion (PC-2) of polymer-coated zinc oxide type fine particles was obtained in the same manner as described in Example 1, except that cyclohexyl methacrylate was used in place of methyl methacrylate in Example 1.

The dispersion (PC-2) of the polymer-coated zinc oxide type fine particles obtained had a nonvolatile content of 21.9%. When the dispersion (PC-2) of the polymer-coated zinc oxide type fine particles was observed with a scanning electron microscope, it was confirmed that the surface of each of the zinc oxide type fine particles was coated with poly(cyclohexyl methacrylate) formed by polymerization in seamless manners.

The fine particles contained in the dispersion (PC-2) of the polymer-coated zinc oxide type fine particles were separated from the dispersion medium by centrifugal separation operation, and the fine particles obtained were washed with isopropyl alcohol and then vacuum dried (under a pressure of 1.33×103 Pa) at 50° C. for 24 hours, to give polymer-coated zinc oxide type fine particles (PCP-2). The number-average particle diameter of the polymer-coated zinc oxide type fine particles (PCP-2) obtained was 28 nm.

### Example 3

A dispersion (PC-3) of polymer-coated zinc oxide type fine particles was obtained in the same manner as described in Example 1, except that styrene was used in place of methyl methacrylate in Example 1.

The dispersion (PC-3) of the polymer-coated zinc oxide type fine particles obtained had a nonvolatile content of 21.7%. When the dispersion (PC-3) of the polymer-coated zinc oxide type fine particles was observed with a scanning electron microscope, it was confirmed that the surface of each of the zinc oxide type fine particles was coated with polystyrene by polymerization in seamless manners.

The fine particles contained in the dispersion (PC-3) of the polymer-coated zinc oxide type fine particles were separated from the dispersion medium by centrifugal separation operation, and the fine particles obtained were washed with isopropyl alcohol and then vacuum dried (under a pressure of 1.33×10³ Pa) at 50° C. for 24 hours, to give polymer-coated zinc oxide type fine particles (PCP-3). The number-average particle diameter of the polymer-coated zinc oxide type fine particles (PCP-3) obtained was 35 nm.

### Example 4

A dispersion (PC-4) of the polymer-coated zinc oxide type fine particles was obtained in the same manner as described in Example 1, except that butyl methacrylate was used instead of methyl methacrylate in Example 1.

The dispersion (PC-4) of the polymer-coated zinc oxide type fine particles obtained had a nonvolatile content of 21.9%. When the dispersion (PC-4) of the polymer-coated zinc oxide type fine particles was observed with a scanning electron microscope, it was confirmed that the surface of each of the zinc oxide type fine particles was coated with poly(butyl methacrylate) formed by polymerization in seamless manners.

The fine particles contained in the dispersion (PC-4) of the polymer-coated zinc oxide type fine particles were separated from the dispersion medium by centrifugal separation operation, and the fine particles obtained were washed with isopropyl alcohol and then vacuum dried (under a pressure of 1.33×10³ Pa) at 50° C. for 24 hours, to give polymer-coated zinc oxide type fine particles (PCP-4). The number-average particle diameter of the polymer-coated zinc oxide type fine particles (PCP-4) obtained was 28 nm.

### Example 5

A dispersion (PC-5) of polymer-coated zinc oxide type fine particles was obtained in the same manner as described in Example 1, except that the zinc oxide type fine particles (DZ-2) was used in place of the zinc oxide type fine particles (DZ-1) in Example 1.

The dispersion (PC-5) of the polymer-coated zinc oxide type fine particles obtained had a nonvolatile content of 21.7%. When the dispersion (PC-5) of the polymer-coated zinc oxide type fine particles was observed with a scanning electron microscope, it was confirmed that the surface of each of the zinc oxide type fine particles was coated with poly(methyl methacrylate) formed by polymerization in seamless manners.

The fine particles contained in the dispersion (PC-5) of the polymer-coated zinc oxide type fine particles were separated from the dispersion medium by centrifugal separation operation, and the fine particles obtained were washed with isopropyl alcohol and then vacuum dried (under a pressure of 1.33×10³ Pa) at 50° C. for 24 hours, to give polymer-coated zinc oxide type fine particles (PCP-5). The number-average particle diameter of the polymer-coated zinc oxide type fine particles (PCP-5) obtained was 35 nm.

### Example 6

A dispersion (PC-6) of polymer-coated zinc oxide type fine particles was obtained in the same manner as described in Example 1, except that the zinc oxide type fine particles (DZ-3) was used in place of the zinc oxide type fine particles (DZ-1) in Example 1.

The dispersion (PC-6) of the polymer-coated zinc oxide type fine particles obtained had a nonvolatile content of 21.9%. When the dispersion (PC-6) of the polymer-coated zinc oxide type fine particles was observed with a scanning electron microscope, it was confirmed that the surface of each of the zinc oxide type fine particles was coated with poly(methyl methacrylate) formed by polymerization in seamless manners.

The fine particles contained in the dispersion (PC-6) of the polymer-coated zinc oxide type fine particles were separated from the dispersion medium by centrifugal separation operation, and the fine particles obtained were washed with isopropyl alcohol and vacuum dried (under a pressure of 1.33×10³ Pa) at 50° C. for 24 hours, to give polymer-coated zinc oxide type fine particles (PCP-6). The number-average particle diameter of the polymer-coated zinc oxide type fine particles (PCP-6) obtained was 75 nm.

### Comparative Example 1

A dispersion (NC-1) of fine particles for comparison was obtained in the same manner as described in Example 1, except that the silane coupling agent (KBM-503 (γ-methacryloxypropyl-trimethoxysilane), available from Shin-Etsu Chemical Co., Ltd.) was not used in Example 1.

The dispersion (NC-1) of fine particles for comparison obtained had a nonvolatile content of 21.9%. When the dispersion (NC-1) of fine particles for comparison was observed with a scanning electron microscope, a number of the zinc oxide type fine particles not coated with a polymer were observed.

The fine particles contained in the dispersion (NC-1) of fine particles for comparison were separated from the dispersion medium by centrifugal separation operation, and the fine particles obtained were washed with isopropyl alcohol and then vacuum dried (under a pressure of 1.33×10³ Pa) at 50° C. for 24 hours, to give a dispersion (NCP-1) for comparison. The number-average particle diameter of the dispersion (NCP-1) for comparison obtained was 28 nm.

### Comparative Example 2

In a 10-L reactor made of glass equipped with a stirrer, a dropping inlet, a thermometer, and a reflux condenser, 0.3 kg of zinc oxide powder was added to and mixed with a mixed solvent of 1.6 kg of acetic acid and 1.6 kg of ion-exchanged water, the mixture was heated to 100° C. with stirring, to give a zinc-containing solution (Al).

Then, 12 kg of 2-butoxyethanol was charged into a 20-L reactor made of glass equipped with a stirrer, a dropping inlet, a thermometer, and a distillate gas outlet, capable of being externally heated by heating a medium, and the mixture was heated to 153° C. and kept at the temperature. The total amount of zinc-containing solution (A1) kept at 100° C. was added dropwise to the reactor with a metering pump over 30 minutes. The temperature of the content in the reactor changed from 153° C. to the content in the reactor changed from 153° C. to 131° C. After completion of the dropwise addition, 500 g of a 2-butoxyethanol solution containing 300.0 g of a methyl methacrylate-hydroxyethyl methacrylate-maleic acid copolymer (8:1:1 by mass ratio; weight-average molecular weight: 4,500), which is a (meth)acrylic resin, was added to the reactor over 1 minute at the time of heating to 168° C. and further kept at the same temperature for 5 hours to give 9.3 kg of a blue gray dispersion. The dispersion was a dispersion in which granule-shaped fine particles having a number-average particle diameter of 32 nm were dispersed at a concentration of 3.8% by mass.

The fine particles contained in the above dispersion was separated from the dispersion medium by centrifugal separation operation, and deionized water was added so that nonvolatile content became 22%, to give a dispersion (NC-2) of fine particles for comparison. When the dispersion (NC-2) of fine particles for comparison was observed with a scanning electron microscope, it was confirmed that the surface of each of the zinc oxide type fine particles was only partially coated with a (meth)acrylic resin.

Then, shown below are the coating film staining property test and coating film water resistance test of the dispersions of the polymer-coated zinc oxide type fine particles obtained in Examples 1 to 6, the dispersions of the fine particles for comparison obtained in Comparative Examples 1 and 2, and the clear coating composition using the zinc oxide type fine particles obtained in Production Example 1.

<<Coating Film Test>>

<Base Coating Composition>

First, 60 g of a dispersant (DEMOL EP, available from KAO Corporation), 50 g of a dispersant (DISCOAT N-14, available from Dai-ichi Kogyo Seiyaku Co., Ltd.), 10 g of a wetting agent (EMULGEN 909, available from KAO Corporation), 210 g of deionized water, 60 g of ethylene glycol, 1,000 g of titanium oxide (CR-95, available from Ishihara Sangyo Kaisha Ltd.), and 10 g of a defoaming agent (NOPCO 8034L, available from SAN NOPCO LIMITED) were mixed, to which 500 g of glass beads (average particle diameter: 2 mm) was added, and the mixture was stirred using a homodisper at 3,000 rpm for 60 minutes, after which the glass beads were removed using a gauze, to give 1,900 g

Then, 300 g of a styrene-acrylic emulsion (ACRYSET EX-41, available from Nippon Shokubai Co., Ltd.), 135 g of the above white paste, 10 g of black paste (UNIRANT 88, available from UNIRANT Co., Ltd.), 1.5 g of a defoaming agent (NOPCO 8034L, available from SAN NOPCO LIMITED), 15 g of butylcellosolve, and 15 g of a film forming aid (CS-12, available from Chisso Corporation) were mixed to give a base coating composition.

<Substrate>

A solvent sealer (V SERAN #200, available from Dai Nippon Toryo Co., Ltd.) was applied to a slate board (NOZAWA Flexible Sheet (JIS A-5403: asbestos cement sheet), available from NOZAWA Corporation) with an air spray so that dry mass became 20 g/m². Then, the base coating composition was applied with a 10-mil applicator, setting for 3 minutes was carried out, and then forced drying was carried out at 100° C. for 10 minutes to give a substrate. The thickness of the coating film (i.e., the coating film obtained with the base coating composition) after drying was 100 μm.

<Clear Coating Composition>

One hundred grams of the dispersion (PC-1) of the polymer-coated zinc oxide type fine particles obtained in Example 1, 200 g of a styrene-acrylic emulsion (ACRYSET EX-41, available from Nippon Shokubai Co., Ltd.), 1.5 g of a defoaming agent (NOPCO 8034L, available from SAN NOPCO LIMITED), 10 g of butylcellosolve, and 10 g of a film forming aid (CS-12, available from Chisso Corporation) were mixed to give a clear coating composition (CR-1).

Also, clear coating compositions (CR-2) to (CR-6) and clear coating compositions (NR-1) and (NR-2) for comparison were prepared in the same manner as described above, except that the dispersions (PC-2) to (PC-6) of the polymer-coated zinc oxide type fine particles obtained in Examples 2 to 6 and the dispersions (NC-1) and (NC-2) of the fine particles for comparison obtained in Comparative Examples 1 and 2 were used respectively in place of the dispersion (PC-1) of the polymer-coated zinc oxide type fine particles obtained in Example 1.

Further, a clear coating composition (NR-3) for comparison was prepared in the same manner as described above, except that 22 g of the zinc oxide type fine particles (DZ-1) obtained in Production Example 1 and 78 g of deionized water were used (hereinafter referred to as “Comparative Example 3”) in place of the dispersion (PC-1) of the polymer-coated zinc oxide type fine particles obtained in Example 1.

<Coating Film Staining Property Test>

The clear coating composition (CR-1) was applied to a substrate with a 10 mil applicator, setting at room temperature for 3 minutes was carried out, and then forced drying was carried out at 100° C. for 10 minutes to give a test coating board (TB-1). The thickness of the coating film (i.e., the coating film obtained with the clear coating composition) after drying was 60 μm.

Also, test coating boards (TB-2) to (TB-6) and test coating boards (NB-1) to (NB-3) for comparison were prepared in the same manner as described above, except that the clear coating compositions (CR-2) to (CR-6) and the clear coating compositions (NR-1) to (NR-3) for comparison were used respectively in place of the clear coating composition (CR-1). The thicknesses of the coating films (i.e., the coating films obtained with the clear coating compositions and the clear coating compositions for comparison) after drying were 60 μm.

The test coating boards (TB-1) to (TB-6) and the test coating board for comparison (NB-1) to (NB-3) obtained above were exposed to air while being faced to a south direction (at a gradient angle of 30 degree) in Suita City, Osaka Prefecture, and a difference (ΔL* value) between the luminance of each coating film after 3 months and the luminance of each coating film at the initial stage was measured in accordance with JIS Z8730 using an integral spectral calorimeter (SE-2000, available from Nippon Denshoku Industries Co., Ltd.), to evaluate the coating film staining properties based on the following evaluation criteria. The results are shown in Table 1. Further, it is indicated that the nearer to zero the ΔL* value is, the less stained the coating film is.

Evaluation criteria:

⊙: ΔL* ≦5;

◯: 5<ΔL*≦10;

Δ: 10<ΔL*≦15;

x: ΔL*>15.

<Coating Film Water Resistance Test>

The clear coating composition (CR-1) was applied to a black acrylic board with a 10 mil applicator, setting at room temperature for 3 minutes was carried out, and then forced drying was carried out at 100° C. for 10 minutes to give a water resistance test board (SCR-1). The thickness of the coating film (i.e., the coating film obtained with the clear coating composition) after drying was 40 μm.

Also, water resistance test boards (SCR-2) to (SCR-6) and water resistance test boards (SNR-1) to (SNR-3) for comparison were obtained in the same manner as described above, except that the clear coating compositions (CR-2) to (CR-6) and the clear coating compositions (NR-1) to (NR-3) for comparison were used respectively in place of the clear coating composition (CR-1). The thicknesses of the coating films (i.e., the coating films obtained with the clear coating compositions or the clear coating compositions for comparison) after drying were 40 μm.

The water resistance test boards (SCR-1) to (SCR-6) and the water resistance test boards (SNR-1) to (SNR-3) for comparison obtained above were immersed in water at 50° C. and left undisturbed for 3 days, and a difference (ΔL* value) between the luminance of each coating film after immersion and leaving undisturbed and the luminance of each coating film before immersion was measured in accordance with JIS Z8730 using an integral spectral calorimeter (SE-2000, available from Nippon Denshoku Industries Co., Ltd.), to evaluate the water resistance based on the following evaluation criteria. The results are shown in Table 1. Further, it is indicated that the nearer to zero the ΔL* value is, the higher the water resistance of the coating film is.

Evaluation criteria:

⊙: ΔL*≦3;

◯: 3<ΔL*≦5;

Δ: 5<ΔL*≦8;

x: ΔL*>8.

TABLE 1

| | | Number- | | | | | | | |
|---|---|---|---|---|---|---|---|---|---|
| | | average | | | | | | | |
| | | particle | | | | | | | |
| | Polymer- | diameter | | | | | | | |
| | coated | of zinc | | Treatment | Coating polymer | | | Coating | |
| | zinc oxide | oxide | | with | of zinc oxide | State of | Clear | film | |
| | type fine | type fine | Element | coupling | type fine | polymer | coating | staining | Water |
| | particles | particles | added | agent | particles | coating | composition | properties | resistance |
| Example 1 | PCP-1 | 20 | — | Yes | Poly(methyl | Excellent; | CR-1 | ◯ | ⊙ |
| | | | | | methacrylate) | No uncoated | | | |
| | | | | | | portions | | | |
| Example 2 | PCP-2 | 20 | — | Yes | Poly(cyclohexyl | Excellent; | CR-2 | ◯ | ⊙ |
| | | | | | methacrylate) | No uncoated | | | |
| | | | | | | portions | | | |
| Example 3 | PCP-3 | 20 | — | Yes | Polystyrene | Excellent; | CR-3 | ◯ | ⊙ |
| | | | | | | No uncoated | | | |
| | | | | | | portions | | | |
| Example 4 | PCP-4 | 20 | — | Yes | Poly(n-butyl | Excellent; | CR-4 | ◯ | ⊙ |
| | | | | | acrylate) | No uncoated | | | |
| | | | | | | portions | | | |
| Example 5 | PCP-5 | 18 | In | Yes | Poly(methyl | Excellent; | CR-5 | ⊙ | ⊙ |
| | | | | | methacrylate) | No uncoated | | | |
| | | | | | | portions | | | |
| Example 6 | PCP-6 | 25 | Al | Yes | Poly(methyl | Excellent; | CR-6 | ⊙ | ⊙ |
| | | | | | methacrylate) | No uncoated | | | |
| | | | | | | portions | | | |
| Comp. Ex. 1 | NCP-1 | 20 | — | No | Poly(methyl | Bad; | NR-1 | X | X |
| | | | | | methacrylate) | Many uncoated | | | |
| | | | | | | particles | | | |
| Comp. Ex. 2 | NCP-2 | 32 | — | No | Methyl | Bad; | NR-2 | Δ | X |
| | | | | | methacrylate- | Uncoated | | | |
| | | | | | cyclohexyl | portions | | | |
| | | | | | methacrylate- | | | | |
| | | | | | maleic acid | | | | |
| | | | | | copolymer | | | | |
| Comp. Ex. 3 | PI-1 | 20 | — | No | — | — | NR-3 | X | X |

As can be seen from Table 1, the polymer-coated zinc oxide type fine particles of Examples 1 to 6, in which the surface of each of zinc oxide type fine particles was treated with a coupling agent, followed by polymer coating treatment, exhibit the excellent polymer coating state having no uncoated portions because the polymer is chemically bonded, through the coupling agent, to the surface of each of the zinc oxide type fine particles, and can provide, when added to coating compositions, coating films having low staining properties, thereby being hardly stained, and having excellent water resistance. In particular, the polymer-coated zinc oxide type fine particles of Examples 5 and 6 in which the zinc oxide type fine particles contain indium or aluminum as a metal element belonging to Group 13 or Group 14 in the long-form periodic table can provide, when added to coating compositions, coating films having extremely low staining properties, thereby being hardly stained.

In contrast, the polymer-coated zinc oxide type fine particles of Comparative Examples 1 and 2, in which the surface of each of zinc oxide type fine particles was subjected to polymer coating treatment without treatment with a coupling agent, exhibit the bad polymer coating state having many uncoated particles or having uncoated portions because the polymer is not chemically bonded, through the coupling agent, to the surface of each of the zinc oxide type fine particles, and can only provide, when added to coating compositions, coating films having high staining properties, thereby being easily stained, and having poor water resistance.

Thus, it is understood that, according to the present invention, when the surface of each of zinc oxide type fine particles having a specific number-average particle diameter is coated with a polymer, the surface of each of the zinc oxide type fine particles is treated with a coupling agent, followed by polymer coating treatment, so that the polymer is chemically bonded, through the coupling agent, to the surface of each of the zinc oxide type fine particles; therefore, the whole surface of each of the zinc oxide type fine particles can be coated with the polymer in seamless manners, and polymer-coated zinc oxide type fine particles can be obtained, which can provide, when added to coating compositions, coating films having low staining properties, thereby being hardly stained, and having excellent water resistance. Such polymer-coated zinc oxide type fine particles can provide, when added to resin compositions, resin formed articles having low staining properties, thereby being hardly stained, and having excellent water resistance.

<<Aqueous Dispersions of Polymer-Coated Metal Oxide Fine Particles and Their Application>>

First, Production Examples 4 to 8 of metal oxide fine particles are shown below.

### Production Example 4

In a 10-L reactor made of glass equipped with a stirrer, a dropping inlet, a thermometer, and a reflux condenser, 0.3 kg of zinc oxide powder was added to and mixed with a mixed solvent of 1.6 kg of acetic acid and 1.6 kg of ion-exchanged water, the mixture was heated to 100° C. with stirring, to obtain a zinc-containing solution (A4).

Then, 12 kg of 2-butoxyethanol was charged into a 20-L reactor made of glass equipped with a stirrer, a dropping inlet, a thermometer, and a distillate gas outlet, capable of being externally heated by heating a medium, and was heated to 153° C. and kept at the same temperature. The total amount of zinc-containing solution (A4) kept at 100° C. was added dropwise to the reactor with a metering pump over 30 minutes. The temperature of the content in the reactor changed from 153° C. to 131° C. After completion of the dropwise addition, 400 g of a 2-butoxyethanol solution in which 36.9 g of lauric acid was dissolved was added over 1 minute at the time of heating to 168° C. and kept at the same temperature for 5 hours to give 7.89 kg of a blue gray dispersion (Z-4). The dispersion (Z-4) was a dispersion in which granule-shaped fine particles having a number-average particle diameter of 20 nm were dispersed at a concentration of 3.7% by mass.

The fine particles contained in the dispersion (Z-4) were separated from the dispersion medium by centrifugal separation operation, and the fine particles obtained were washed with isopropyl alcohol and then vacuum dried (under a pressure of 1.33×10³ Pa) at 50° C. for 24 hours, to give zinc oxide type fine particles (DZ-4). The zinc oxide type fine particles (DZ-4) obtained had a number-average particle diameter of 20 nm.

### Production Example 5

In a 2-L reactor made of glass equipped with a stirrer, a dropping inlet, a nitrogen gas introducing tube, a thermometer, and a reflux condenser, 180 g of the zinc oxide type fine particles (DZ-4) was added to and mixed with 1,020 g of deionized water. Then, 28.6 g of tetraethoxysilane and 100 g of ethanol were placed into a dropping funnel (1), and 14.5 g of 25% aqueous ammonia and 14.5 g of deionized water were placed into a dropping funnel (2). After heating the reactor to 50° C., the contents of dropping funnels (1) and (2) were simultaneously added dropwise to the reactor over 1 hour. After completion of the dropwise addition, the mixture was kept at 50° C. for 5 hours. Then, 10 g of a 20% aqueous solution of an anionic surfactant (EMAL 0 (sodium lauryl sulfate); available from KAO Corporation) was added to the mixture, and 10 g of a silane coupling agent (KBM-503 (γ-methacryloxy-propyltrimethoxysilane), available from Shin-Etsu Chemical Co., Ltd.) was added to the mixture over 10 minutes. Then, after aging at 50° C. for 3 hours, the mixture was cooled to room temperature to give a dispersion of silica-coated zinc oxide fine particles (SZ-5).

The fine particles contained in the dispersion (SZ-5) was separated from the dispersion medium by centrifugal separation operation, and the fine particles obtained were washed with isopropyl alcohol and then vacuum dried (under a pressure of 1.33×10³ Pa) at 50° C. for 24 hours, to give silica-coated zinc oxide fine particles (DSZ-5). The silica-coated zinc oxide fine particles (DSZ-5) obtained had a number-average particle diameter of 60 nm.

### Production Example 6

In a 2-L reactor made of glass equipped with a stirrer, a dropping inlet, a nitrogen gas introducing tube, a thermometer, and a reflux condenser, 50 g of the zinc oxide type fine particles (DZ-4) was added to and mixed with 950 g of deionized water. The reaction solution was heated to 80° C., and an aqueous solution of sodium silicate at 10% by mass as SiO₂, relative to zinc oxide, was added thereto with stirring. After aging for 10 min, sulfuric acid was added thereto with stirring over 60 minutes for neutralization to pH6.5. After aging for 30 min, the mixture was cooled to room temperature to give a dispersion of silica-coated zinc oxide fine particles (SZ-6).

The fine particles contained in the dispersion (SZ-6) were separated from the dispersion medium by centrifugal separation operation, and the fine particles obtained were washed with isopropyl alcohol and then vacuum dried (under a pressure of 1.33×10³ Pa) at 50° C. for 24 hours, to give silica-coated zinc oxide fine particles (DSZ-6). The silica-coated zinc oxide fine particles (DSZ-6) obtained had a number-average particle diameter of 45 nm.

### Production Example 7

A dispersion (ST-7) of silica-coated titanium oxide fine particles was obtained in the same manner as described in Production Example 5, except that 1,200 g of titanium oxide fine particles (NTB NANOTITANIA, available from Showa Denko K.K.; number-average particle diameter: 10 to 20 nm) was used in place of 180 g of the zinc oxide type fine particles (DZ-4) and 1,020 g of deionized water in Production Example 5.

The fine particles contained in the dispersion (ST-7) were separated from the dispersion medium by centrifugal separation operation, and the fine particles obtained were washed with isopropyl alcohol and then vacuum dried (under a pressure of 1.33×10³ Pa) at 50° C. for 24 hours, to give silica-coated titanium oxide fine particles (DST-7). The silica-coated titanium oxide fine particles (DST-7) obtained had a number-average particle diameter of 55 nm.

### Production Example 8

A dispersion (ST-8) of silica-coated titanium oxide fine particles was obtained in the same manner as described in Production Example 6, except that 1,000 g of titanium oxide fine particles (NTB NANOTITANIA, available from Showa Denko K.K.; number-average particle diameter: 10 to 20 nm) was used in place of 50 g of the zinc oxide type fine particles (DZ-4) and 950 g of deionized water in Production Example 6.

The fine particles contained in the dispersion (ST-8) were separated from the dispersion medium by centrifugal separation operation, and the fine particles obtained were washed with isopropyl alcohol and then vacuum dried (under a pressure of 1.33×10³ Pa) at 50° C. for 24 hours, to give silica-coated titanium oxide fine particles (DST-8). The silica-coated titanium oxide fine particles (DST-8) obtained had a number-average particle diameter of 45 nm.

Then, Examples 7 to 13 and Comparative Examples 4 and 5 concerning the production of polymer-coated metal oxide fine particles are shown below.

### Example 7

To a 2-L reactor made of glass equipped with a stirrer, a dropping inlet, a nitrogen gas introducing tube, a thermometer, and a reflux condenser, 200 g of the zinc oxide type fine particles (DZ-4; number-average particle diameter: 20 nm), 800 g of deionized water, and 10 g of a 20% aqueous solution of an anionic surfactant (EMAL 0 (sodium lauryl sulfate), available from KAO Corporation) were added under a nitrogen gas blow, followed by mixing, and the mixture was heated to 50° C. with stirring. Then, 10 g of a silane coupling agent (KBM-503 (γ-methacryloxy-propyltrimethoxysilane), available from Shin-Etsu Chemical Co., Ltd.) was added dropwise to the reactor with stirring over 30 minutes, and after completion of the dropwise addition, the mixture was kept at 50° C. for 5 hours.

Then, the mixture was heated to 80° C., and 20 g of methyl methacrylate, 1 g of a 5% aqueous solution of potassium persulfate, and 1 g of a 5% azo initiator (VA-057 (2,2′-azobis[N-(2-caroboxy-ethyl)-2-methylpropionamidine]tetrahydrate), available from Wako Pure Chemical Industries, Ltd.) were added thereto. The mixture was kept with stirring for 5 hours to give an aqueous dispersion (PC-7) of polymer-coated zinc oxide type fine particles.

The aqueous dispersion (PC-7) of the polymer-coated zinc oxide type fine particles obtained had a nonvolatile content of 21.8%, and the total recovered amount was 1,038 g. When the aqueous dispersion (PC-7) of the polymer-coated zinc oxide type fine particles was observed with a scanning electron microscope, it was confirmed that the surface of each of the zinc oxide type fine particles was coated with poly(methyl methacrylate) formed by polymerization in seamless manners. Further, when the residual amount of methyl methacrylate was measured by gas chromatography for the aqueous dispersion (PC-7) of the polymer-coated zinc oxide type fine particles, it was found to be 68 ppm.

The fine particles contained in the aqueous dispersion (PC-7) of the polymer-coated zinc oxide type fine particles were separated from the dispersion medium by centrifugal separation operation, and the fine particles obtained were washed with isopropyl alcohol and then vacuum dried (under a pressure of 1.33×10³ Pa) at 50° C. for 24 hours, to give polymer-coated zinc oxide type fine particles (PCP-7). The number-average particle diameter of the polymer-coated zinc oxide type fine particles (PCP-7) was 53 nm, and when thermal mass loss was measured at the temperature-raising condition from 100° C. to 500° C., mass reduction of 10.7% was observed. Accordingly, a ratio of a total amount of residual monomer to a total amount of polymer coating was 0.29% by mass.

### Example 8

To a 2-L reactor made of glass equipped with a stirrer, a dropping inlet, a nitrogen gas introducing tube, a thermometer, and a reflux condenser, 210 g of the silica-coated zinc oxide fine particles (DSZ-5; number-average particle diameter: 60 nm), 800 g of deionized water, and 10 g of a 20% aqueous solution of an anionic surfactant (EMAL 0 (sodium lauryl sulfate), available from KAO Corporation) were added under a nitrogen gas blow, followed by mixing, and the mixture was heated to 80° C. with stirring.

Then, 3 g of methyl methacrylate, 10 g of butyl acrylate, and 1 g of a 5% aqueous solution of potassium persulfate were added thereto. The mixture was kept with stirring for 5 hours, but 1 g of 5% ammonium persulfate was divided into three portions and each portion was added by every 15 minutes at an interval of 2 hours after the addition of the initial initiator, to give an aqueous dispersion (PC-8) of polymer-coated silica-coated zinc oxide fine particles.

The aqueous dispersion (PC-8) of the polymer-coated silica-coated zinc oxide fine particles obtained had a nonvolatile content of 21.6%, and the total recovered amount was 1,057 g. When the aqueous dispersion (PC-8) of the polymer-coated silica-coated zinc oxide fine particles was observed with a scanning electron microscope, it was confirmed that the surface of each of the silica-coated zinc oxide fine particles was coated with a copolymer of methyl methacrylate and butyl acrylate formed by polymerization. Further, when the residual amount of methyl methacrylate and butyl acrylate was measured by gas chromatography for the aqueous dispersion (PC-8) of the polymer-coated silica-coated zinc oxide fine particles, it was found to be 32 ppm.

The fine particles contained in the aqueous dispersion (PC-8) of the polymer-coated silica-coated zinc oxide fine particles were separated from the dispersion medium by centrifugal separation operation, and the fine particles obtained were washed with isopropyl alcohol and then vacuum dried (under a pressure of 1.33×10³ Pa) at 50° C. for 24 hours, to give polymer-coated silica-coated zinc oxide fine particles (PCP-8). The number-average particle diameter of the polymer-coated silica-coated zinc oxide fine particles (PCP-8) was 125 nm, and when thermal mass loss was measured at the temperature-raising condition from 100° C. to 500° C., mass reduction of 8.1% was observed. Accordingly, a ratio of a total amount of residual monomer to a total amount of polymer coating was 0.18% by mass.

### Example 9

To a 2-L reactor made of glass equipped with a stirrer, a dropping inlet, a nitrogen gas introducing tube, a thermometer, and a reflux condenser, 200 g of the silica-coated zinc oxide fine particles (DSZ-6; number-average particle diameter: 45 nm), 1,000 g of deionized water, and 10 g of a 20% aqueous solution of an anionic surfactant (EMAL 0 (sodium lauryl sulfate), available from KAO Corporation) were added under a nitrogen gas blow, followed by mixing, and the mixture was heated to 50° C. with stirring. Then, 10 g of a silane coupling agent (KBM-503 (γ-meth-acryloxypropyltrimethoxysilane), available from Shin-Etsu Chemical Co., Ltd.) was added dropwise to the reactor with stirring over 30 minutes, and after completion of the dropwise addition, the mixture was kept at 50° C. for 5 hours.

Then, the mixture was heated to 80° C., and 20 g of methyl methacrylate, 40 g of butyl acrylate, 1 g of a 5% aqueous solution of potassium persulfate, and 1 g of a 5% azo initiator (VA-057 (2,2′-azo-bis[N-(2-caroboxyethyl)-2-methylpropionamidine]tetrahydrate), available from Wako Pure Chemical Industries, Ltd.) were added thereto. The mixture was kept with stirring for 5 hours to give an aqueous dispersion (PC-9) of polymer-coated silica-coated zinc oxide fine particles.

The aqueous dispersion (PC-9) of the polymer-coated silica-coated zinc oxide fine particles obtained had a nonvolatile content of 21.0%, and the total recovered amount was 1,279 g. When the aqueous dispersion (PC-9) of the polymer-coated silica-coated zinc oxide fine particles was observed with a scanning electron microscope, it was confirmed that the surface of each of the silica-coated zinc oxide fine particles was coated with a copolymer of methyl methacrylate and butyl acrylate formed by polymerization. Further, when the residual amount of methyl methacrylate and butyl acrylate was measured by gas chromatography for the aqueous dispersion (PC-9) of the polymer-coated silica-coated zinc oxide fine particles, it was found to be 74 ppm.

The fine particles contained in the aqueous dispersion (PC-9) of the polymer-coated silica-coated zinc oxide fine particles were separated from the dispersion medium by centrifugal separation operation, and the fine particles obtained were washed with isopropyl alcohol and then vacuum dried (under a pressure of 1.33×10³ Pa) at 50° C. for 24 hours, to give polymer-coated silica-coated zinc oxide fine particles (PCP-9). The number-average particle diameter of the polymer-coated silica-coated zinc oxide fine particles (PCP-9) was 85 nm, and when thermal mass loss was measured at the temperature-raising condition from 100° C. to 500° C., mass reduction of 23.8% was observed. Accordingly, a ratio of a total amount of residual monomer to a total amount of polymer coating was 0.15% by mass.

### Example 10

To a 2-L reactor made of glass equipped with a stirrer, a dropping inlet, a nitrogen gas introducing tube, a thermometer, and a reflux condenser, 200 g of silica-coated zinc oxide fine particles (NANOFINE-50A, available from Sakai Chemical Industry Co., Ltd.; number-average particle diameter: 25 nm), 1,000 g of deionized water, and 10 g of a 20% aqueous solution of an anionic surfactant (SBL-3N-27 (sodium polyoxy-ethylene alkyl ether sulfate), available from Nikko Chemicals Co., Ltd.) were added under a nitrogen gas blow, followed by mixing, and the mixture was heated to 50° C. with stirring. Then, 10 g of a silane coupling agent (KBE-503 (γ-meth-acryloxypropyltriethoxysilane), available from Shin-Etsu Chemical Co., Ltd.) was added dropwise to the reactor with stirring over 30 minutes, and after completion of the dropwise addition, the mixture was kept at 50° C. for 5 hours.

Then, the mixture was heated to 80° C., and 40 g of methyl methacrylate, 40 g of cyclohexyl methacrylate, 1 g of a 5% aqueous solution of potassium persulfate, and 1 g of a 5% azo initiator (VA-057 (2,2′-azobis[N-(2-caroboxy-ethyl)-2-methylpropionamidine]tetrahydrate), available from Wako Pure Chemical Industries, Ltd.) were added thereto. The mixture was kept with stirring for 5 hours, but 1 g of a 5% azo initiator (VA-057 (2,2′-azobis[N-(2-caroboxy-ethyl)-2-methylpropionamidine]tetrahydrate), available from Wako Pure Chemical Industries, Ltd.) was divided into three portions and each portion was added by every 15 minutes at an interval of 2 hours after the addition of the initial initiator, to give an aqueous dispersion (PC-10) of the polymer-coated silica-coated zinc oxide fine particles.

The aqueous dispersion (PC-10) of the polymer-coated silica-coated zinc oxide fine particles obtained had a nonvolatile content of 22.1%, and the total recovered amount was 1,300 g. When the aqueous dispersion (PC-10) of the polymer-coated silica-coated zinc oxide fine particles was observed with a scanning electron microscope, it was confirmed that the surface of each of the silica-coated zinc oxide fine particles was coated with a copolymer of methyl methacrylate and cyclohexyl methacrylate formed by polymerization. Further, when the residual amount of methyl methacrylate and cyclohexyl methacrylate was measured by gas chromatography for the aqueous dispersion (PC-10) of the polymer-coated silica-coated zinc oxide fine particles, it was found to be 10 ppm.

The fine particles contained in the aqueous dispersion (PC-10) of the polymer-coated silica-coated zinc oxide fine particles were separated from the dispersion medium by centrifugal separation operation, and the fine particles obtained were washed with isopropyl alcohol and then vacuum dried (under a pressure of 1.33×10³ Pa) at 50° C. for 24 hours, to give polymer-coated silica-coated zinc oxide fine particles (PCP-10). The number-average particle diameter of the polymer-coated silica-coated zinc oxide fine particles (PCP-10) was 61 nm, and when thermal mass loss was measured at the temperature-raising condition from 100° C. to 500° C., mass reduction of 29.2% was observed. Accordingly, a ratio of a total amount of residual monomer to a total amount of polymer coating was 0.02% by mass.

### Example 11

To a 2-L reactor made of glass equipped with a stirrer, a dropping inlet, a nitrogen gas introducing tube, a thermometer, and a reflux condenser, 200 g of titanium oxide fine particles (NANOTITANIA NTB, available from Showa Denko K.K.; number-average particle diameter: 18 nm), 1,000 g of deionized water, and 10 g of a 20% aqueous solution of an anionic surfactant (SBL-3N-27 (sodium polyoxyethylene alkyl ether sulfate), available from Nikko Chemicals Co., Ltd.) were added under a nitrogen gas blow, followed by mixing, and the mixture was heated to 50° C. with stirring. Then, 10 g of a silane coupling agent (KBE-503 (y-methacryloxypropyltriethoxysilane), available from Shin-Etsu Chemical Co., Ltd.) was added dropwise to the reactor with stirring over 30 minutes, and after completion of the dropwise addition, the mixture was kept at 50° C. for 5 hours.

Then, the mixture was heated to 80° C., and 40 g of methyl methacrylate, 40 g of cyclohexyl meth-acrylate, 10 g of styrene, 1 g of a 5% aqueous solution of potassium persulfate, and 1 g of a 5% azo initiator (VA-057 (2,2′-azobis[N-(2-caroboxy-ethyl)-2-methylpropionamidine]tetrahydrate), available from Wako Pure Chemical Industries, Ltd.) were added thereto. The mixture was kept with stirring for 5 hours, but 1 g of a 5% azo initiator (VA-057 (2,2′-azobis[N-(2-caroboxy-ethyl)-2-methylpropionamidine]tetrahydrate), available from Wako Pure Chemical Industries, Ltd.) was divided into three portions and each portion was added by every 15 minutes at an interval of 2 hours after the addition of the initial initiator, to give an aqueous dispersion (PC-11) of polymer-coated titanium oxide fine particles.

The aqueous dispersion (PC-11) of the polymer-coated titanium oxide fine particles obtained had a nonvolatile content of 22.5%, and the total recovered amount was 1,298 g. When the aqueous dispersion (PC-11) of the polymer-coated titanium oxide fine particles was observed with a scanning electron microscope, it was confirmed that the surface of each of the titanium oxide fine particles was coated with a copolymer of methyl methacrylate, cyclohexyl methacrylate, and styrene formed by polymerization. Further, when the residual amount of methyl methacrylate, cyclohexyl methacrylate, and styrene was measured by gas chromatography for the aqueous dispersion (PC-11) of the polymer-coated titanium oxide fine particles, it was found to be 74 ppm.

The fine particles contained in the aqueous dispersion (PC-11) of the polymer-coated titanium oxide fine particles were separated from the dispersion medium by centrifugal separation operation, and the fine particles obtained were washed with isopropyl alcohol and then vacuum dried (under a pressure of 1.33×10³ Pa) at 50° C. for 24 hours, to give polymer-coated titanium oxide fine particles (PCP-11). The number-average particle diameter of the polymer-coated titanium oxide fine particles (PCP-11) was 48 nm, and when thermal mass loss was measured at the temperature-raising condition from 100° C. to 500° C., mass reduction of 30.9% was observed. Accordingly, a ratio of a total amount of residual monomer to a total amount of polymer coating was 0.11% by mass.

### Example 12

To a 2-L reactor made of glass equipped with a stirrer, a dropping inlet, a nitrogen gas introducing tube, a thermometer, and a reflux condenser, 210 g of the silica-coated titanium oxide fine particles (DST-7; number-average particle diameter: 55 nm), 800 g of deionized water, and 10 g of a 20% aqueous. solution of an anionic surfactant (EMAL 0 (sodium lauryl sulfate), available from KAO Corporation) were added under a nitrogen gas blow, followed by mixing, and the mixture was heated to 80° C. with stirring.

Then, 30 g of butyl methacrylate, 30 g of styrene, and 1 g of a 5% aqueous solution of potassium persulfate were added thereto. The mixture was kept with stirring for 5 hours, but 1 g of 5% ammonium persulfate was divided into three portions and each portion was added by every 15 minutes at an interval of 2 hours after the addition of the initial initiator, to give an aqueous dispersion (PC-12) of polymer-coated silica-coated titanium oxide fine particles.

The aqueous dispersion (PC-12) of the polymer-coated silica-coated titanium oxide fine particles obtained had a nonvolatile content of 25.0%, and the total recovered amount was 1,078 g. When the aqueous dispersion (PC-12) of the polymer-coated silica-coated titanium oxide fine particles was observed with a scanning electron microscope, it was confirmed that the surface of each of the silica-coated titanium oxide fine particles was coated with a copolymer of butyl methacrylate and styrene formed by polymerization. Further, when the residual amount of butyl methacrylate and styrene was measured by gas chromatography for the aqueous dispersion (PC-12) of the polymer-coated silica-coated titanium oxide fine particles, it was found to be 21 ppm.

The fine particles contained in the aqueous dispersion (PC-12) of the polymer-coated silica-coated titanium oxide fine particles were separated from the dispersion medium by centrifugal separation operation, and the fine particles obtained were washed with isopropyl alcohol and then vacuum dried (under a pressure of 1.33×10³ Pa) at 50° C. for 24 hours, to give polymer-coated silica-coated titanium oxide fine particles (PCP-12). The number-average particle diameter of the polymer-coated silica-coated titanium oxide fine particles (PCP-12) was 142 nm, and when thermal mass loss was measured at the temperature-raising condition from 100° C. to 500° C., mass reduction of 23.6% was observed. Accordingly, a ratio of a total amount of residual monomer to a total amount of polymer coating was 0.04% by mass.

### Example 13

To a 2-L reactor made of glass equipped with a stirrer, a dropping inlet, a nitrogen gas introducing tube, a thermometer, and a reflux condenser, 200 g of the silica-coated titanium oxide fine particles (DST-8; number-average particle diameter: 45 nm), 1,000 g of deionized water, and 10 g of an anionic surfactant (SBL-3N-27 (sodium polyoxyethylene alkyl ether sulfate), available from Nikko Chemicals Co., Ltd.) were added under a nitrogen gas blow, followed by mixing, and the mixture was heated to 50° C. with stirring. Then, 10 g of a silane coupling agent (KBM-503 (γ-methacryloxypropyltrimethoxysilane), available from Shin-Etsu Chemical Co., Ltd.) was added dropwise to the reactor with stirring over 30 minutes, and after completion of the dropwise addition, the mixture was kept at 50° C. for 5 hours.

Then, the mixture was heated to 80° C., and 30 g of methyl methacrylate, 40 g of cyclohexyl methacrylate, 1 g of a 5% aqueous solution of potassium persulfate, and 1 g of a 5% azo initiator (VA-057 (2,2′-azobis[N-(2-caroboxy-ethyl)-2-methylpropionamidine]tetrahydrate), available from Wako Pure Chemical Industries, Ltd.) were added thereto. The mixture was kept with stirring for 5 hours to give an aqueous dispersion (PC-13) of polymer-coated silica-coated titanium oxide fine particles.

The aqueous dispersion (PC-13) of the polymer-coated silica-coated titanium oxide fine particles obtained had a nonvolatile content of 21.6%, and the total recovered amount was 1,289 g. When the aqueous dispersion (PC-13) of the polymer-coated silica-coated titanium oxide fine particles was observed with a scanning electron microscope, it was confirmed that the surface of each of the silica-coated titanium oxide fine particles was coated with a copolymer of methyl methacrylate and cyclohexyl methacrylate formed by polymerization. Further, when the residual amount of methyl methacrylate and cyclohexyl methacrylate was measured by gas chromatography for the aqueous dispersion (PC-13) of the polymer-coated silica-coated titanium oxide fine particles, it was found to be 43 ppm.

The fine particles contained in the aqueous dispersion (PC-13) of the polymer-coated silica-coated titanium oxide fine particles were separated from the dispersion medium by centrifugal separation operation, and the fine particles obtained were washed with isopropyl alcohol and then vacuum dried (under a pressure of 1.33×10³ Pa) at 50° C. for 24 hours, to give polymer-coated silica-coated titanium oxide fine particles (PCP-13). The number-average particle diameter of the polymer-coated silica-coated titanium oxide fine particles (PCP-13) was 90 nm, and when thermal mass loss was measured at the temperature-raising condition from 100° C. to 500° C., mass reduction of 26.3% was observed. Accordingly, a ratio of a total amount of residual monomer to a total amount of polymer coating was 0.08% by mass.

### Comparative Example 4

To a 2-L reactor made of glass equipped with a stirrer, a dropping inlet, a nitrogen gas introducing tube, a thermometer, and a reflux condenser, 200 g of silica-coated zinc oxide fine particles (NANOFINE-50A, available from Sakai Chemical Industry Co., Ltd.; number-average particle diameter: 25 nm), 1,000 g of deionized water, and 10 g of an anionic surfactant (SBL-3N-27 (sodium polyoxyethylene alkyl ether sulfate), available from Nikko Chemicals Co., Ltd.) were added under a nitrogen gas blow, followed by mixing, and the mixture was heated to 50° C. with stirring. Then, 10 g of a silane coupling agent (KBE-503 (γ-methacryloxypropyltriethoxysilane), available from Shin-Etsu Chemical Co., Ltd.) was added dropwise to the reactor with stirring over 30 minutes, and after completion of the dropwise addition, the mixture was kept at 50° C. for 5 hours.

Then, the mixture was heated to 80° C., and 40 g of methyl methacrylate, 40 g of cyclohexyl methacrylate, and 2 g of a 5% aqueous solution of potassium persulfate were added thereto. The mixture was kept with stirring for 5 hours to give an aqueous dispersion (NPC-4) of polymer-coated silica-coated zinc oxide fine particles.

The aqueous dispersion (NPC-4) of the polymer-coated silica-coated zinc oxide fine particles obtained had a nonvolatile content of 20.4%, and the total recovered amount was 1,298 g. When the aqueous dispersion (NPC-4) of the polymer-coated silica-coated zinc oxide fine particles was observed with a scanning electron microscope, it was confirmed that the surface of each of the silica-coated zinc oxide fine particles was coated with a copolymer of methyl methacrylate and cyclohexyl methacrylate formed by polymerization. Further, when the residual amount of methyl methacrylate and cyclohexyl methacrylate was measured by gas chromatography for the aqueous dispersion (NPC-4) of the polymer-coated silica-coated zinc oxide fine particles, it was found to be 890 ppm.

The fine particles contained in the aqueous dispersion (NPC-4) of the polymer-coated silica-coated zinc oxide fine particles was separated from the dispersion medium by centrifugal separation operation, and the fine particles obtained were washed with isopropyl alcohol and then vacuum dried (under a pressure of 1.33×10³ Pa) at 50° C. for 24 hours, to give polymer-coated silica-coated zinc oxide fine particles (NCP-4). The number-average particle diameter of the polymer-coated silica-coated zinc oxide fine particles (NCP-4) was 74 nm, and when thermal mass loss was measured at the temperature-raising condition from 100° C. to 500° C., mass reduction of 28.0% was observed. Accordingly, a ratio of a total amount of residual monomer to a total amount of polymer coating was 1.56% by mass.

### Comparative Example 5

To a 2-L reactor made of glass equipped with a stirrer, a dropping inlet, a nitrogen gas introducing tube, a thermometer, and a reflux condenser, 200 g of titanium oxide fine particles (NANOTITANIA NTB, available from Showa Denko K.K.; number-average particle diameter: 18 nm), 1,000 g of deionized water, and 10 g of an anionic surfactant (SBL-3N-27 (sodium polyoxyethylene alkyl ether sulfate); available from Nikko Chemicals Co., Ltd.) were added under a nitrogen gas blow, followed by mixing, and the mixture was heated to 50° C. with stirring. Then, 10 g of a silane coupling agent (KBE-503 (γ-methacryloxy-propyltriethoxysilane), available from Shin-Etsu Chemical Co., Ltd.) was added dropwise to the reactor with stirring over 30 minutes, and after completion of the dropwise addition, the mixture was kept at 50° C. for 5 hours.

Then, the mixture was heated to 80° C., and 40 g of methyl methacrylate, 40 g of cyclohexyl methacrylate, 10 g of styrene, and 2 g of a 5% aqueous solution of potassium persulfate were added thereto. The mixture was kept for 5 hours to give an aqueous dispersion (NPC-5) of polymer-coated titanium oxide fine particles.

The aqueous dispersion (NPC-5) of the polymer-coated titanium oxide fine particles obtained had a nonvolatile content of 21.2%, and the total recovered amount was 1,306 g. When the aqueous dispersion (NPC-5) of the polymer-coated titanium oxide fine particles was observed with a scanning electron microscope, it was confirmed that the surface of each of the titanium oxide fine particles was partially coated with a copolymer of methyl methacrylate, cyclohexyl methacrylate, and styrene formed by polymerization. Further, when the residual amount of methyl methacrylate, cyclohexyl methacrylate, and styrene was measured by gas chromatography for the aqueous dispersion (NPC-5) of the polymer-coated titanium oxide fine particles, it was found to be 1,280 ppm.

The fine particles contained in the aqueous dispersion (NPC-5) of the polymer-coated titanium oxide fine particles were separated from the dispersion medium by centrifugal separation operation, and the fine particles obtained were washed with isopropyl alcohol and then vacuum dried (under a pressure of 1.33×10³ Pa) at 50° C. for 24 hours, to give polymer-coated titanium oxide fine particles (NCP-5). The number-average particle diameter of the polymer-coated titanium oxide fine particles (NCP-5) was 74 nm, and when thermal mass loss was measured at the temperature-raising condition from 100° C. to 500° C., mass reduction of 29.5% was observed. Accordingly, a ratio of a total amount of residual monomer to a total amount of polymer coating was 2.05% by mass.

Then, shown below are the coating film test and coating film water resistance test of the aqueous dispersions of the polymer-coated metal oxide fine particles obtained in Examples 7 to 10, the aqueous dispersions of the fine particles for comparison obtained in Comparative Examples 4 and 5, and a clear coating composition using commercially available silica-coated zinc oxide fine particles.

<<Coating Film Test>>

<Base Coating Composition>

First, 60 g of a dispersant (DEMOL EP, available from KAO Corporation), 50 g of a dispersant (DISCOAT N-1, available from Dai-ichi Kogyo Seiyaku Co., Ltd.), 10 g of a wetting agent (EMULGEN 909, available from KAO Corporation), 210 g of deionized water, 60 g of ethylene glycol, 1,000 g of titanium oxide (CR-95, available from Ishihara Sangyo Kaisha Ltd.), and 10 g of a defoaming agent (NOPCO 8034L, available from SAN NOPCO LIMITED) were mixed, to which 500 g of glass beads (average particle diameter: 2 mm) was added, and the mixture was stirred using a homodisper at 3,000 rpm for 60 minutes, after which the glass beads were removed using a gauze, to give 1,900 g of white paste.

Then, 300 g of styrene-acrylic emulsion (ACRYSET EX-41, available from Nippon Shokubai Co., Ltd.), 135 g of the above white paste, 10 g of black paste (UNIRANT 88, available from UNIRANT Co., Ltd.), 1.5 g of a defoaming agent (NOPCO 8034L, available from SAN NOPCO LIMITED), 15 g of butylcellosolve, and 15 g of a film forming aid (CS-12, available from Chisso Corporation) were mixed to give a base coating composition.

<Substrate>

A solvent sealer (DAN Transparent Sealer, available from Nippon Paint Co., Ltd.) was applied to a slate board (NOZAWA Flexible Sheet (JIS A-5403: asbestos cement sheet), available from NOZAWA Corporation) with an air spray so that dry mass became 20 g/m². Then, the base coating composition was applied with a 10 mil applicator, setting for 3 minutes was carried out, and then forced drying was carried out at 100° C. for 10 minutes to give a substrate. The thickness of the coating film (i.e., the coating film obtained with the base coating composition) after drying was 100 μm.

<Clear Coating Composition>

One hundred grams of the aqueous dispersion (PC-7) of the polymer-coated zinc oxide type fine particles obtained in Example 7, 200 g of styrene-acrylic emulsion (ACRYSET EX-41, available from Nippon Shokubai Co., Ltd.), 1.5 g of a defoaming agent (NOPCO 8034L, available from SAN NOPCO LIMITED), 10 g of butylcellosolve, and 10 g of a film forming aid (CS-12, available from Chisso Corporation) were mixed to give a clear coating composition (CR-12).

Also, clear coating compositions (CR-8) to (CR-13) and clear paint compositions (NR-4) and (NR-5) for comparison were prepared in the same manner as described above, except that the aqueous dispersions (PC-8) to (PC-10) of the polymer-coated silica-coated zinc oxide fine particles obtained in Examples 8 to 10, the aqueous dispersion (PC-11) of the polymer-coated titanium oxide fine particles obtained in Example 11, the aqueous dispersions (PC-12) and (PC-13) of the polymer-coated silica-coated titanium oxide fine particles obtained in Examples 12 and 13, and the aqueous dispersions (NC-4) and (NC-5) of the fine particles for comparison obtained in Comparative Examples 4 and 5 were used respectively in place of the aqueous dispersion (PC-7) of the polymer-coated zinc oxide type fine particles obtained in Example 7.

Further, a clear coating composition (NR-6) for comparison was prepared in the same manner as described above, except that 20 g of silica-coated zinc oxide fine particles (NANOFINE-50A, available from Sakai Chemical Industry Co., Ltd.; number-average particle diameter: 25 nm) and 80 g of deionized water were used (hereinafter referred to as “Comparative Example 6”) in place of the aqueous dispersion (PC-7) of the polymer-coated zinc oxide type fine particles obtained in Example 7.

<Coating Film Water Resistance Test>

The clear coating composition (CR-7) was applied to a black acrylic board (3 mm×75 mm×150 mm; L*=1.89; available from Nippon Testpanel Co., Ltd.) prepared by extrusion of methyl methacrylate in accordance with JIS K6717, with a 10 mil applicator, setting for 3 minutes at room temperature was carried out, and then forced drying was carried out at 100° C. for 10 minutes to give a water resistance test board (SCR-7). The thickness of the coating film (i.e., the coating film obtained with the clear coating composition) after drying was 40 μm.

Also, water resistance test boards (SCR-8) to (SCR-13) and water resistance test boards (SNR-4) to (SNR-6) for comparison were obtained in the same manner as described above, except that the clear coating compositions (CR-8) to (CR-13) and the clear coating compositions (NR-4) to (NR-6) for comparison were used respectively in place of the clear coating composition (CR-7). The thicknesses of the coating films (i.e., the coating films obtained with the clear coating compositions or the clear coating compositions for comparison) after drying was 40 μm.

The water resistance test boards (SCR-7) to (SCR-13) and the water resistance test boards (SNR-4) to (SNR-6) for comparison obtained above were immersed in deionized water at 23° C. and left undisturbed for 1 week. The water resistance test boards were taken out to wipe moisture with a boards were taken out to wipe moisture with a paper towel, and a color difference was measured within 1 minute after taking out the water resistance test boards. Further, the water resistance test boards were left undisturbed under an atmosphere at a temperature of 23° C. and a relative humidity of 25% for 24 hours, and a color difference was measured after confirming the return of whitening. Further, a color difference was measured by a difference (ΔL* value) between the luminance of each coating film just after taking out or after 24 hours and the luminance of each coating film before immersion in accordance with JIS Z8730 using an integral spectral calorimeter (SE-2000, available from Nippon Denshoku Industries Co., Ltd.), to evaluate the water resistance based on the following evaluation criteria. The results are shown in Table 2. Further, it is indicated that the nearer to zero the ΔL* value is, the higher the water resistance of the coating film is.

Evaluation criteria:

Just after taking out:

⊙: ΔL*≦2;

◯: 2<ΔL*≦4;

x: ΔL*>6.

After 24 hours:

⊙: ΔL*≦1;

◯: 1<ΔL*≦2;

Δ: 2<ΔL*≦3;

x: ΔL*>3.

<Coating Film Weather Resistance Test>

The clear coating composition (CR-7) was applied to a substrate with a 10 mil applicator, setting for 3 minutes at room temperature was carried out, and then forced drying was carried out at 100° C. for 10 minutes to give a test coating board (WCR-7). The thickness of the coating film (i.e., the coating film obtained with the clear coating composition) after drying was 40 μm.

Further, the weather resistance test boards (WCR-8) to (WCR-13) and the weather resistance test boards (WNR-4) to (WNR-6) for comparison were obtained in the same manner as described above, except that the clear coating compositions (CR-8) to (CR-13) and the clear coating compositions (NR-4) to (NR-6) for comparison were used respectively in place of the clear coating composition (CR-7). The thicknesses of the coating films (i.e., the coating films obtained the clear coating compositions or the clear coating composition for comparison) after drying was 40 μm.

An accelerating weather resistance test using a weather tester (Sunshine Super Long Life Weather Meter WEL-SUN-HC-B type, available from Suga Test Instruments Co., Ltd.) was carried out for the weather resistance test boards (WCR-7) to (WCR-13) and the weather resistance test boards (WNR-4) to (WNR-6) for comparison obtained above, and a 60° mirror plane gloss value of each coating film before the start of test and after the lapse of 1,200 hours were measured. Gloss retention rate (%) was calculated by the formula:
GR=(A/B)×100
wherein GR represents the gloss retention rate of a coating film, A represents the 60° mirror plane gloss value of the coating film after the lapse of 1,200 hours of the accelerating weather resistance test, and B represents the 60° mirror plane gloss value of the coating film before the start of the accelerating weather resistance test, and the weather resistance of each coating film was evaluated. The results are shown in Table 2. Further, it is indicated that the higher the gloss retention rate (%) is, the higher the weather resistance of the coating film is.

The accelerating weather resistance test was carried out using a sunshine carbon arc lump (WS shape) defined in JIS A 1415 4. (Accelerating exposure tester) published in 1995 according to the test method defined in 5. (Test method). Further, the mirror gloss value of each coating film was measured in accordance with JIS K5400 using a gloss meter (VZ-2000, available from Nippon Denshoku Industries Co., Ltd.), setting the incident angle of light from a light source to be 60°.

TABLE 2

| | Aqueous | | | Ratio of total | | Water | | |
|---|---|---|---|---|---|---|---|---|
| | dispersion of | | Number-average | amount of | | resistance | | Weather |
| | polymer- | | particle | residual monomer | | Just | | resistance |
| | coated metal | Metal oxide | diameter of | to total amount | Clear | after | After | gloss |
| | oxide fine | fine | metal oxide fine | of polymer coat | coating | taking | 24 | ratention |
| | particles | particles | particles | (% by mass) | composition | out | hours | rate |
| Example 7 | PC-7 | Zinc oxide | 20 | 0.29 | CR-7 | ⊙ | ⊙ | 86 |
| | | type fine | | | | | | |
| | | particles | | | | | | |
| Example 8 | PC-8 | Silica-coated | 60 | 0.18 | CR-8 | ◯ | ◯ | 84 |
| | | zinc oxide | | | | | | |
| | | fine | | | | | | |
| | | particles | | | | | | |
| Example 9 | PC-9 | Silica-coated | 45 | 0.15 | CR-9 | ⊙ | ⊙ | 90 |
| | | zinc oxide | | | | | | |
| | | fine | | | | | | |
| | | particles | | | | | | |
| Example 10 | PC-10 | Silica-coated | 25 | 0.02 | CR-10 | ⊙ | ⊙ | 91 |
| | | zinc oxide | | | | | | |
| | | fine | | | | | | |
| | | particles | | | | | | |
| Example 11 | PC-11 | Titanium | 18 | 0.11 | CR-11 | ⊙ | ⊙ | 76 |
| | | oxide fine | | | | | | |
| | | particles | | | | | | |
| Example 12 | PC-12 | Silica-coated | 55 | 0.04 | CR-12 | ⊙ | ⊙ | 82 |
| | | titanium | | | | | | |
| | | oxide fine | | | | | | |
| | | particles | | | | | | |
| Example 13 | PC-13 | Silica-coated | 45 | 0.08 | CR-13 | ⊙ | ⊙ | 84 |
| | | titanium | | | | | | |
| | | oxide fine | | | | | | |
| | | particles | | | | | | |
| Comp. Ex. 4 | NPC-4 | Silica-coated | 25 | 1.56 | NR-4 | Δ | ◯ | 68 |
| | | titanium | | | | | | |
| | | oxide fine | | | | | | |
| | | particles | | | | | | |
| Comp. Ex. 5 | NPC-5 | Silica-coated | 18 | 2.05 | NR-5 | X | Δ | 53 |
| | | titanium | | | | | | |
| | | oxide fine | | | | | | |
| | | particles | | | | | | |
| Comp. Ex. 6 | — | Silica-coated | 25 | — | NR-6 | Δ | Δ | 67 |
| | | titanium | | | | | | |
| | | oxide fine | | | | | | |
| | | particles | | | | | | |

As can be seen from Table 2, the aqueous dispersions of the polymer-coated metal oxide fine particles of Examples 7 to 13 can provide, when added to coating compositions, coating films having excellent water resistance and excellent weather resistance, because the metal oxide fine particles have a number-average particle diameter within a specific range and a ratio of a total amount of residual monomer to a total amount of polymer coating is not greater than 0.5% by mass.

In contrast, the aqueous dispersions of the polymer-coated metal oxide fine particles of Comparative Examples 4 and 5 can only provide, when added to coating compositions, coating films having poor water resistance and poor weather resistance, because the metal oxide fine particles have a number-average particle diameter within a specific range but a ratio of a total amount of residual monomer to a total amount of polymer coating is higher than 0.5% by mass. Also, in the same manner, the coating composition of Comparative Example 6 using silica-coated zinc oxide fine particles subjected to no polymer coating treatment can only provide coating films having poor water resistance and poor weather resistance.

Thus, it is understood that, according to the present invention, when an aqueous dispersion of polymer-coated metal oxide fine particles in which the surface of each of metal oxide fine particles is coated with a polymer, a ratio of a total amount of residual monomer to a total amount of polymer coating is reduced to a specific value or lower, so that the resultant aqueous dispersion of polymer-coated metal oxide fine particles can provide, when added to coating compositions, coating films having excellent water resistance and excellent weather resistance, and can provide, when added to resin compositions, resin formed articles having excellent water resistance and excellent weather resistance.

### INDUSTRIAL APPLICABILITY

In particular, polymer-coated zinc oxide type fine particles in the polymer-coated metal oxide fine particles of the present invention can provide coating films and resin formed articles both having low staining properties and improved water resistance while keeping excellent properties possessed by zinc oxide; therefore, the recoating cycle of the external walls of buildings and bridges can be prolonged to reduce their maintenance costs, and further, the life of resin formed articles can be prolonged to enhance their commercial values, whereby they make a great contribution in the fields of construction exterior finish and resin formed articles.

The aqueous dispersion of polymer-coated metal oxide fine particles of the present invention can provide coating films and resin formed articles both having remarkably improved water resistance and weather resistance while keeping excellent properties possessed by the metal oxide, so that the recoating cycle of the external walls of buildings and bridges can be prolonged to reduce their maintenance costs, and further, the life of the resin formed articles can be prolonged to enhance their commercial values, whereby they make a great contribution in the fields of construction external finish and resin formed articles.

The present invention has been fully described by way of Examples, it is to be understood that various changes and modifications will be apparent to those skilled in the art. Therefore, unless such changes and modifications depart from the scope of the present invention defined below, they should be construed as being included therein. The scope of the present invention, therefore, should be determined by the following claims.

The Japanese Patent Laid-open (Kokai) Publications cited above are incorporated herein by reference.

1. Polymer-coated metal oxide fine particles, comprising metal oxide fine particles having a number-average particle diameter of not smaller than 1 nm and not greater than 100 nm, a surface of each of the metal oxide fine particles being coated with a polymer.

2. The polymer-coated metal oxide fine particles according to claim 1, wherein the polymer-coated metal oxide fine particles are polymer-coated zinc oxide type fine particles comprising zinc oxide type fine particles having a number-average particle diameter of not smaller than 5 nm and not greater than 100 nm, a surface of each of the zinc oxide type fine particles being coated with a polymer, which polymer is chemically bonded, through a coupling agent, to the surface of each of the zinc oxide type fine particles.

3. The polymer-coated metal oxide fine particles according to claim 2, wherein the coupling agent is a silane coupling agent.

4. The polymer-coated metal oxide fine particles according to claim 2, wherein the zinc oxide type fine particles comprise at least one metal element selected from a group consisting of metal elements belonging to groups 13 and 14 in the long-form periodic table.

5. The polymer-coated metal oxide fine particles according to claim 4, wherein the metal element is aluminum and/or indium.

6. The polymer-coated metal oxide fine particles according to claim 2, wherein the polymer-coated zinc oxide type fine particles has a number-average particle diameter of not smaller than 10 nm and not greater than 200 nm.

7. The polymer-coated metal oxide fine particles according to claim 2, which are used for coating compositions or resin compositions.

8. A dispersion of polymer-coated metal oxide fine particles, comprising polymer-coated metal oxide fine particles according to claim 2 dispersed in a dispersion medium.

9. The dispersion of polymer-coated metal oxide fine particles according to claim 8, wherein the polymer-coated metal oxide fine particles are polymer-coated zinc oxide type fine particles, comprising zinc oxide type fine particles having a number-average molecular weight of not smaller than 5 nm and not greater than 100 nm, a surface of each of the zinc oxide type fine particles being coated with a polymer, which polymer is formed by emulsion polymerization using a polymerizable monomer and a radical initiator.

10. An aqueous dispersion of polymer-coated metal oxide fine particles, comprising polymer-coated metal oxide fine particles according to claim 1, which polymer is formed by emulsion polymerization using a polymerizable monomer and a radical initiator.

11. The aqueous dispersion of polymer-coated metal oxide fine particles according to claim 10, wherein a ratio of a total amount of residual monomer to a total amount of polymer coating is not greater than 0.5% by mass.

12. The aqueous dispersion of polymer-coated metal oxide fine particles according to claim 11, wherein the metal oxide fine particles comprise zinc oxide type fine particles, titanium oxide fine particles, silica fine particles, silica coated zinc oxide fine particles, or silica coated titanium oxide fine particles.

13. The aqueous dispersion of polymer-coated metal oxide fine particles according to claim 11, wherein the metal oxide fine particles are treated with a coupling agent in advance of emulsion polymerization.

14. A coating composition comprising polymer-coated metal oxide fine particles according to claim 7 and a binder component capable of forming a coating film in which the polymer-coated metal oxide fine particles are dispersed.

15. A coating composition comprising an aqueous dispersion of polymer-coated metal oxide fine particles according to claim 11.

16. A resin composition comprising polymer-coated metal oxide fine particles according to claim 7 and a resin component capable of forming a continuous phase in which the polymer-coated metal oxide fine particles are dispersed.

17. A resin composition comprising an aqueous dispersion of polymer-coated metal oxide fine particles according to claim 11.

18. A resin formed article obtained by forming a resin composition according to claim 16 in one shape selected from a plate, a sheet, a film, and a fiber.

19. A resin formed article obtained by forming a resin composition according to claim 17 in one shape selected from a plate, a sheet, a film, and a fiber.

20. A process for producing an aqueous dispersion of polymer-coated metal oxide fine particles according to claim 11, comprising carrying out emulsion polymerization using a polymerizable monomer and a radical initiator in a presence of metal oxide fine particles having a number-average particle diameter of not smaller than 1 nm and not greater than 100 nm, in which case two or more radical initiators having different half-life periods are used as radical initiators.

21. A process for producing an aqueous dispersion of polymer-coated metal oxide fine particles according to claim 11, comprising carrying out emulsion polymerization using a polymerizable monomer and a radical initiator in a presence of metal oxide fine particles having a number-average particle diameter of not smaller than 1 nm and not greater than 100 nm, in which case one part of the radical initiator is added to a reaction system, and after an interval, the other part of the radical initiator is added to the reaction system.
